(19) United States
(12) Patent Application Publication
(10) Pub. No.: US 2025/0055542 A1
(43) Pub. Date: Feb. 13, 2025

(54) CHANNEL MEASUREMENT METHOD AND COMMUNICATION APPARATUS

(71) Applicant: HUAWEI TECHNOLOGIES CO., LTD., Shenzhen (CN)

(72) Inventors: Lei Dong, Shanghai (CN); Xiaoyan Bi, Shanghai (CN); Yong Liu, Shanghai (CN); Xiaojun Xi, Shenzhen (CN)

(73) Assignee: HUAWEI TECHNOLOGIES CO., LTD., Shenzhen (CN)

(21) Appl. No.: 18/930,856

(22) Filed: Oct. 29, 2024

Related U.S. Application Data
(63) Continuation of application No. PCT/CN2023/090569, filed on Apr. 25, 2023.

(30) Foreign Application Priority Data
Apr. 29, 2022 (CN) 202210465192.8

(51) Int. Cl. H04B 7/06; H04B 17/20

(52) U.S. Cl. CPC H04B 7/0626; H04B 17/201

(57) ABSTRACT

Embodiments of this application provide a channel measurement method and a communication apparatus. The method includes: A first apparatus receives K signals, where the K signals correspond to K ports. The first apparatus measures the K signals to obtain measurement results, where the measurement results are used to determine channel state information corresponding to R ports, R is greater than K, and K is greater than or equal to 1. According to solutions provided in embodiments of this application, resource overheads for channel measurement can be reduced.

### CROSS-REFERENCE TO RELATED APPLICATIONS

This application is a continuation of International Application No. PCT/CN2023/090569, filed on Apr. 25, 2023, which claims priority to Chinese Patent Application No. 202210465192.8, filed on Apr. 29, 2022. The disclosures of the aforementioned applications are hereby incorporated by reference in their entireties.

### TECHNICAL FIELD

Embodiments of this application relate to the communication field, and more specifically, to a channel measurement method and a communication apparatus.

### BACKGROUND

In research of a 6th generation (6G) mobile communication technology, to implement technical innovations in integration of communication and data, computing, and intelligent sensing, and the like, reflection devices start to be widely researched. The reflection device can reflect a received signal and data. Compared with a transmitter device and a receiver device in an existing wireless network, the reflection device is easy to deploy, is compatible with an existing device, has low energy consumption and complexity, and can run in a full-duplex mode, and therefore spectrum efficiency is high. The reflection device includes an antenna panel, where the antenna panel includes at least one antenna, and the antenna may be used as a reflection component. The reflection device may control radio channel fading by configuring an amplitude and a phase of each antenna, to form an expected directional beam. To implement a device gain, the reflection device needs a large quantity of physical antennas.

In a communication system, to transmit data and obtain synchronization information of the communication system and channel feedback information, an uplink channel and/or a downlink channel need/needs to be estimated. In a new radio (NR) system, a plurality of signals used for channel measurement are defined, and different signals correspond to different ports. When a quantity of ports increases, a quantity of physical resources used for channel measurement also increases, and the quantity of ports is positively correlated with the quantity of physical antennas. Therefore, if a channel measurement technology of the NR system is used in a communication system with a large quantity of antennas, resource overheads for channel measurement are high.

### SUMMARY

Embodiments of this application provide a channel measurement method and a communication apparatus, to reduce resource overheads for channel measurement.

According to a first aspect, a channel measurement method is provided. The method may be performed by a first apparatus, or may be performed by a component (for example, a chip or a chip system) configured in the first apparatus. This is not limited in this application. The first apparatus may be a terminal device or a network device. The method includes: The first apparatus receives K signals, where the K signals are in one-to-one correspondence with K ports. The first apparatus measures the K signals to obtain measurement results, where the measurement results are used to determine channel state information corresponding to R ports, R is greater than K, and K is greater than or equal to 1.

According to the foregoing solution, a quantity of ports for channel measurement can be reduced, that is, a quantity of signals used for channel measurement can be reduced, so that resource overheads for channel measurement can be reduced. In other words, this solution can increase a proportion of resources used for data transmission, that is, can improve frequency efficiency and a throughput rate of a system.

With reference to the first aspect, in some implementations of the first aspect, the first apparatus sends the measurement results, where the measurement results and a correspondence between the K ports and the R ports are used to determine the channel state information.

According to the foregoing solution, the first apparatus sends the measurement results, so that a peer end can determine, based on the measurement results and the correspondence between the K ports and the R ports, the channel state information corresponding to the R ports, to reduce operation complexity and energy consumption of the first apparatus.

With reference to the first aspect, in some implementations of the first aspect, the first apparatus determines, based on the measurement results and a correspondence between the K ports and the R ports, the channel state information corresponding to the R ports, and sends the channel state information.

According to the foregoing solution, the first apparatus determines, based on the measurement results and a correspondence between the K ports and the R ports, the channel state information corresponding to the R ports, and sends the channel state information to the peer end, to reduce operation complexity and energy consumption of the peer end.

With reference to the first aspect, in some implementations of the first aspect, a correspondence between the K ports and the R ports includes: the K ports are ports in the R ports, the K ports and the R ports include at least one same port, or the K ports are different from the R ports.

With reference to the first aspect, in some implementations of the first aspect, the K signals correspond to at least one of the following: a first antenna subarray set of a second apparatus and a second antenna subarray set of a third apparatus, where the first antenna subarray set includes at least one antenna subarray, the second antenna subarray set includes at least one antenna subarray, and the antenna subarray includes at least one antenna.

According to the foregoing solution, the second apparatus end and/or the third apparatus end classify/classifies an antenna into an antenna subarray, where the antenna subarray corresponds to a signal used for channel measurement. Because the antenna subarray may include at least one antenna, all antennas in the antenna subarray may not need to be estimated during channel measurement, so that resource overheads for channel measurement can be reduced.

With reference to the first aspect, in some implementations of the first aspect, the first apparatus obtains first information, where the first information is used to determine the correspondence between the K ports and the R ports, and the first information includes at least one of the following: quantity information of the antenna subarray in the first antenna subarray set, quantity information of the antenna subarray in the second antenna subarray set, quantity information of antennas in the antenna subarray, and information about a correspondence between the antenna subarray and antennas for sending the K signals.

With reference to the first aspect, in some implementations of the first aspect, the K signals correspond to at least one of the following: a first antenna set that is determined by a second apparatus and that is used for channel measurement, and a second antenna set that is determined by a third apparatus and that is used for channel measurement.

According to the foregoing solution, the second apparatus and/or the third apparatus determine/determines that an antenna used for channel measurement corresponds to a signal used for channel measurement, and all antennas at the second apparatus end and/or the third apparatus end may not need to be estimated during channel measurement, so that resource overheads for channel measurement can be reduced.

With reference to the first aspect, in some implementations of the first aspect, the first apparatus obtains second information, where the second information is used to determine the correspondence between the K ports and the R ports, and the second information includes at least one of the following: information about a distance from an antenna in the first antenna set to an antenna panel center, phase information of the antenna in the first antenna set, information about a distance from an antenna in the second antenna set to an antenna panel center, and phase information of the antenna in the second antenna set.

With reference to the first aspect, in some implementations of the first aspect, the first apparatus obtains third information, where the third information is used to determine the correspondence between the K ports and the R ports, and the third information includes at least one of the following: row information of an antenna in the first antenna set in a horizontal direction of an antenna panel, column information of the antenna in the first antenna set in a vertical direction of the antenna panel, row information of an antenna in the second antenna set in a horizontal direction of an antenna panel, and column information of the antenna in the second antenna set in a vertical direction of the antenna panel.

According to a second aspect, a channel measurement method is provided. The method may be performed by a second apparatus, or may be performed by a component (for example, a chip or a chip system) configured in the second apparatus. This is not limited in this application. The second apparatus may be a terminal device or a network device. The method includes: The second apparatus sends K signals, where the K signals are used for channel measurement, the K signals are in one-to-one correspondence with K ports. The second apparatus obtains channel state information corresponding to R ports, where the channel state information is determined based on measurement results of the K signals, R is greater than K, and K is greater than or equal to 1.

According to the foregoing solution, a quantity of ports for channel measurement can be reduced, that is, a quantity of signals used for channel measurement can be reduced, so that resource overheads for channel measurement can be reduced. In other words, this solution can increase a proportion of resources used for data transmission, that is, can improve frequency efficiency and a throughput rate of a system.

With reference to the second aspect, in some implementations of the second aspect, that the second apparatus obtains channel state information corresponding to R ports includes: The second apparatus receives the measurement results of the K signals, and determines the channel state information based on the measurement results and a correspondence between the K ports and the R ports.

According to the foregoing solution, the second apparatus receives the measurement results sent by a peer end, and determines, based on the measurement results and the correspondence between the K ports and the R ports, the channel state information corresponding to the R ports, to reduce operation complexity and energy consumption of the peer end.

With reference to the second aspect, in some implementations of the second aspect, a correspondence between the K ports and the R ports includes: the K ports are ports in the R ports, the K ports and the R ports include at least one same port, or the K ports are different from the R ports.

With reference to the second aspect, in some implementations of the second aspect, the K signals correspond to at least one of the following: a first antenna subarray set of the second apparatus and a second antenna subarray set of a third apparatus, where the first antenna subarray set includes at least one antenna subarray, the second antenna subarray set includes at least one antenna subarray, and the antenna subarray includes at least one antenna.

According to the foregoing solution, the second apparatus end and/or the third apparatus end classify/classifies an antenna into an antenna subarray, where the antenna subarray corresponds to a signal used for channel measurement. Because the antenna subarray may include at least one antenna, all antennas in the antenna subarray may not need to be estimated during channel measurement, so that resource overheads for channel measurement can be reduced.

With reference to the second aspect, in some implementations of the second aspect, the second apparatus sends first information, where the first information is used to determine the correspondence between the K ports and the R ports, and the first information includes at least one of the following: quantity information of the antenna subarray in the first antenna subarray, quantity information of the antenna subarray in the second antenna subarray, quantity information of the antenna in the antenna subarray, and information about a correspondence between the antenna subarray and antennas for sending the K signals.

With reference to the second aspect, in some implementations of the second aspect, the K signals correspond to at least one of the following: a first antenna set that is determined by the second apparatus and that is used for channel measurement, and a second antenna set that is determined by a third apparatus and that is used for channel measurement.

According to the foregoing solution, the second apparatus and/or the third apparatus determine/determines that an antenna used for channel measurement corresponds to a signal used for channel measurement, and all antennas at the second apparatus end and/or the third apparatus end may not need to be estimated during channel measurement, so that resource overheads for channel measurement can be reduced.

With reference to the second aspect, in some implementations of the second aspect, the second apparatus sends second information, where the second information is used to determine the correspondence between the K ports and the R ports, and the second information includes at least one of the following: information about a distance from an antenna in the first antenna set to an antenna panel center, phase information of the antenna in the first antenna set, information about a distance from an antenna in the second antenna set to an antenna panel center, and phase information of the antenna in the second antenna set.

With reference to the second aspect, in some implementations of the second aspect, the second apparatus sends third information, where the third information is used to determine the correspondence between the K ports and the R ports, and the third information includes at least one of the following: row information of an antenna in the first antenna set in a horizontal direction of an antenna panel, column information of the antenna in the first antenna set in a vertical direction of the antenna panel, row information of an antenna in the second antenna set in a horizontal direction of an antenna panel, and column information of the antenna in the second antenna set in a vertical direction of the antenna panel.

According to a third aspect, a communication apparatus is provided. The apparatus may be a first apparatus or a component (for example, a chip or a chip system) configured in the first apparatus. This is not limited in this application. The first apparatus may be a terminal device or a network device. The apparatus includes a processing unit and a transceiver unit. The transceiver unit is configured to receive K signals, where the K signals are in one-to-one correspondence with K ports. The processing unit is configured to measure the K signals to obtain measurement results, where the measurement results are used to determine channel state information corresponding to R ports, R is greater than K, and K is greater than or equal to 1.

With reference to the third aspect, in some implementations of the third aspect, the transceiver unit is further configured to send the measurement results, where the measurement results and a correspondence between the K ports and the R ports are used to determine the channel state information.

With reference to the third aspect, in some implementations of the third aspect, the processing unit is further configured to determine, based on the measurement results and a correspondence between the K ports and the R ports, the channel state information corresponding to the R ports; and the transceiver unit is further configured to send the channel state information.

With reference to the third aspect, in some implementations of the third aspect, the K signals correspond to at least one of the following: a first antenna subarray set of a second apparatus and a second antenna subarray set of a third apparatus, where the first antenna subarray set includes at least one antenna subarray, the second antenna subarray set includes at least one antenna subarray, and the antenna subarray includes at least one antenna.

With reference to the third aspect, in some implementations of the third aspect, the transceiver unit is further configured to obtain first information, where the first information is used to determine the correspondence between the K ports and the R ports, and the first information includes at least one of the following: quantity information of the antenna subarray in the first antenna subarray set, quantity information of the antenna subarray in the second antenna subarray set, quantity information of antennas in the antenna subarray, and information about a correspondence between the antenna subarray and antennas for sending the K signals.

With reference to the third aspect, in some implementations of the third aspect, the K signals correspond to at least one of the following: a first antenna set that is determined by a second apparatus and that is used for channel measurement, and a second antenna set that is determined by a third apparatus and that is used for channel measurement.

With reference to the third aspect, in some implementations of the third aspect, the transceiver unit is further configured to obtain second information, where the second information is used to determine the correspondence between the K ports and the R ports, and the second information includes at least one of the following: information about a distance from an antenna in the first antenna set to an antenna panel center, phase information of the antenna in the first antenna set, information about a distance from an antenna in the second antenna set to an antenna panel center, and phase information of the antenna in the second antenna set.

With reference to the third aspect, in some implementations of the third aspect, the transceiver unit is further configured to obtain third information, where the third information is used to determine the correspondence between the K ports and the R ports, and the third information includes at least one of the following: row information of an antenna in the first antenna set in a horizontal direction of an antenna panel, column information of the antenna in the first antenna set in a vertical direction of the antenna panel, row information of an antenna in the second antenna set in a horizontal direction of an antenna panel, and column information of the antenna in the second antenna set in a vertical direction of the antenna panel.

According to a fourth aspect, a communication apparatus is provided. The apparatus may be a second apparatus or a component (for example, a chip or a chip system) configured in the second apparatus. This is not limited in this application. The second apparatus may be a terminal device or a network device. The apparatus includes a processing unit and a transceiver unit. The transceiver unit is configured to send K signals, where the K signals are used for channel measurement, and the K signals are in one-to-one correspondence with K ports; and the transceiver unit is further configured to obtain channel state information corresponding to R ports, where the channel state information is determined based on measurement results of the K signals, R is greater than K, and K is greater than or equal to 1.

With reference to the fourth aspect, in some implementations of the fourth aspect, the transceiver unit is further configured to receive the measurement results of the K signals; and the processing unit is configured to determine the channel state information based on the measurement results and a correspondence between the K ports and the R ports.

With reference to the fourth aspect, in some implementations of the fourth aspect, the K signals correspond to at least one of the following: a first antenna subarray set of the second apparatus and a second antenna subarray set of a third apparatus, where the first antenna subarray set includes at least one antenna subarray, the second antenna subarray set includes at least one antenna subarray, and the antenna subarray includes at least one antenna.

With reference to the fourth aspect, in some implementations of the fourth aspect, the transceiver unit is further configured to send first information, where the first information is used to determine the correspondence between the K ports and the R ports, and the first information includes at least one of the following: quantity information of the antenna subarray in the first antenna subarray, quantity information of the antenna subarray in the second antenna subarray, quantity information of the antenna in the antenna subarray, and information about a correspondence between the antenna subarray and antennas for sending the K signals.

With reference to the fourth aspect, in some implementations of the fourth aspect, the K signals correspond to at least one of the following: a first antenna set that is determined by the second apparatus and that is used for channel measurement, and a second antenna set that is determined by a third apparatus and that is used for channel measurement.

With reference to the fourth aspect, in some implementations of the fourth aspect, the transceiver unit is further configured to send second information, where the second information is used to determine the correspondence between the K ports and the R ports, and the second information includes at least one of the following: information about a distance from an antenna in the first antenna set to an antenna panel center, phase information of the antenna in the first antenna set, information about a distance from an antenna in the second antenna set to an antenna panel center, and phase information of the antenna in the second antenna set.

With reference to the fourth aspect, in some implementations of the fourth aspect, the transceiver unit is further configured to send third information, where the third information is used to determine the correspondence between the K ports and the R ports, and the third information includes at least one of the following: row information of an antenna in the first antenna set in a horizontal direction of an antenna panel, column information of the antenna in the first antenna set in a vertical direction of the antenna panel, row information of an antenna in the second antenna set in a horizontal direction of an antenna panel, and column information of the antenna in the second antenna set in a vertical direction of the antenna panel.

According to a fifth aspect, a communication apparatus is provided. The apparatus includes a processor. The processor is coupled to a memory, and may be configured to execute instructions in the memory, to implement the method according to either of the first aspect and the second aspect and any one of the implementations of the first aspect and the second aspect. Optionally, the apparatus further includes the memory. The memory and the processor may be separately deployed, or may be deployed in a centralized manner. Optionally, the apparatus further includes a communication interface, and the processor is coupled to the communication interface.

In an implementation, the communication interface may be a transceiver or an input/output interface.

In another implementation, the apparatus is a first apparatus or a second apparatus, or a chip configured in the first apparatus or the second apparatus. When the apparatus is a chip, the communication interface may be an input/output interface, an interface circuit, an output circuit, an input circuit, a pin, a related circuit, or the like on the chip or a chip system. The processor may alternatively be embodied as a processing circuit or a logic circuit.

Optionally, the transceiver may be a transceiver circuit. Optionally, the input/output interface may be an input/output circuit.

In an implementation process, the processor may be one or more chips, the input circuit may be an input pin, the output circuit may be an output pin, and the processing circuit may be a transistor, a gate circuit, a trigger, any logic circuit, or the like. An input signal received by the input circuit may be received and input by, but not limited to, a receiver, a signal output by the output circuit may be output to, but not limited to, a transmitter and transmitted by the transmitter, and the input circuit and the output circuit may be a same circuit, where the circuit is used as the input circuit and the output circuit at different moments. Implementations of the processor and the various circuits are not limited in embodiments of this application.

According to a sixth aspect, a communication apparatus is provided. The apparatus includes a logic circuit and an input/output interface, and the logic circuit is configured to: be coupled to the input/output interface, and transmit data through the input/output interface, to perform the method according to either of the first aspect and the second aspect and any one of the implementations of the first aspect and the second aspect.

According to a seventh aspect, a computer-readable storage medium is provided. The computer-readable storage medium stores a computer program (which may also be referred to as code or instructions). When the computer program is run on a computer, the computer is enabled to perform the method according to either of the first aspect and the second aspect and any one of the implementations of the first aspect and the second aspect.

According to an eighth aspect, a computer program product is provided. The computer program product includes a computer program (which may also be referred to as code or instructions). When the computer program is run, a computer is enabled to perform the method according to either of the first aspect and the second aspect and any one of the implementations of the first aspect and the second aspect.

For beneficial effects brought by the third aspect to the eighth aspect, refer to the descriptions of the beneficial effects in the first aspect and the second aspect. Details are not described herein again.

### BRIEF DESCRIPTION OF DRAWINGS

FIG. 1 is a diagram of a system architecture according to an embodiment of this application;

FIG. 2 is an interaction flowchart of a channel measurement method according to an embodiment of this application;

FIG. 3 to FIG. 5 each are a diagram of classification into an antenna subarray according to an embodiment of this application;

FIG. 6 to FIG. 8 each are a diagram of selecting an antenna based on a distance and a phase according to an embodiment of this application;

FIG. 9 to FIG. 12 each are a diagram of selecting an antenna based on a row and a column according to an embodiment of this application;

FIG. 13 is a diagram of a communication apparatus according to an embodiment of this application;

FIG. 14 is a diagram of a structure of a communication apparatus according to an embodiment of this application;

FIG. 15 is a diagram of a structure of another communication apparatus according to an embodiment of this application; and

FIG. 16 is a diagram of a structure of still another communication apparatus according to an embodiment of this application.

### DESCRIPTION OF EMBODIMENTS

The following describes technical solutions of embodiments in this application with reference to accompanying drawings.

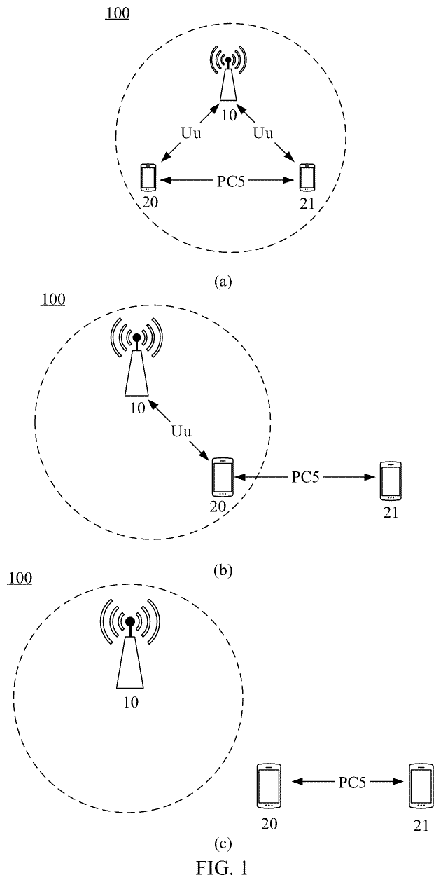

FIG. 1 is a diagram of a system architecture according to an embodiment of this application. As shown in FIG. 1, embodiments of this application may be applied to a system in which a network device communicates with a terminal device, or applied to a system in which terminal devices directly communicate with each other. In addition, embodiments of this application may be applied to a communication scenario with network coverage, or may be applied to a communication scenario without network coverage. In other words, the terminal device in embodiments of this application may be located within a coverage area of the network device, or may be located outside a coverage area of the network device. This is not limited in this embodiment of this application.

A communication system 100 shown in (a) in FIG. 1 includes a network device 10, a terminal device 20, and a terminal device 21. Both the terminal device 20 and the terminal device 21 are within a coverage area of the network device 10, the network device 10 and the terminal device communicate with each other through an air interface between a terrestrial radio access network and user equipment (UTRAN UE, Uu), and the terminal devices 20 and 21 communicate with each other through a PC5 interface. A communication system 100 shown in (b) in FIG. 1 includes a network device 10, a terminal device 20, and a terminal device 21. The terminal device 20 is within a coverage area of the network device 10, and the terminal device 21 is outside the coverage area of the network device 10. A communication system 100 shown in (c) in FIG. 1 includes a network device 10, a terminal device 20, and a terminal device 21. Neither the terminal device 20 nor the terminal device 21 is within a coverage area of the network device 10.

When the system architecture in this embodiment of this application is applied to Uu air interface transmission, both parties in wireless communication include a network device and a terminal device. When the system architecture in this embodiment of this application is applied to sidelink (SL) air interface transmission, both parties in wireless communication are terminal devices. This is not limited in this embodiment of this application.

It should be understood that quantities of terminal devices and network devices shown in FIG. 1 are merely examples, and quantities of terminal devices and network devices in the communication system are not limited in this application.

The terminal device in embodiments of this application may also be referred to as a terminal, an access terminal, user equipment, a subscriber unit, a subscriber station, a mobile station, a mobile console, a remote station, a remote terminal, a mobile device, a user terminal, a wireless communication device, a user agent, or a user apparatus. The terminal in embodiments of this application may be a mobile phone, a tablet computer (pad), a computer having a wireless transceiver function, a virtual reality (VR) terminal, an augmented reality (AR) terminal, a wireless terminal in industrial control, a wireless terminal in self driving, a wireless terminal in telemedicine (remote medical), a wireless terminal in a smart grid, a wireless terminal in transportation safety, a wireless terminal in a smart city, a wireless terminal in a smart home (, a cellular phone, a cordless phone, a session initiation protocol SIP) phone, a wireless local loop (WLL) station, a personal digital assistant (PDA), a handheld device having a wireless communication function, a computing device or another processing device connected to a wireless modem, a vehicle-mounted device, a wearable device, a terminal in a 5G network, a terminal in a network evolved after 5G, or the like.

The wearable device may also be referred to as a wearable smart device, and is a general term of wearable devices developed by intelligently designing daily wear by using a wearable technology, such as glasses, gloves, a watch, clothing, and shoes. The wearable device is a portable device that is directly worn on the body or integrated into clothes or an accessory of a user. The wearable device is not only a hardware device, but also implements a powerful function through software support, data exchange, and cloud interaction. In broad sense, wearable smart devices include full-featured and large-sized devices that can implement complete or partial functions without depending on smartphones, such as smart watches or smart glasses, and devices that focus only on an application function and need to work with other devices such as smartphones, such as various smart bands or smart jewelry.

The network device in embodiments of this application may be any communication device that has a wireless transceiver function and that is configured to communicate with user equipment, may be a network device deployed on a satellite, or may be a network device deployed on the ground. The network device includes but is not limited to an evolved NodeB (eNB), a radio network controller (RNC), a NodeB (NB), a base station controller (BSC), a base transceiver station (BTS), a home base station (for example, a home evolved NodeB (HeNB), or a home NodeB (HNB)), a baseband unit (BBU), an access point (AP) in a wireless fidelity (Wi-Fi) system, a wireless relay node, a wireless backhaul node, a transmission point (TP), a transmission reception point (TRP), or the like. Alternatively, the network device may be a gNB in a 5G system, for example, an NR system, may be one antenna panel or a group of antenna panels (including a plurality of antenna panels) of a base station in a 5G system, or may be a network node, for example, a baseband unit (BBU) or a distributed unit (DU), that constitutes a gNB or a transmission point.

In some deployments, the gNB may include a central unit (CU) and a DU. The gNB may further include an active antenna unit (AAU).

Technical solutions in embodiments of this application may be applied to various communication systems, for example, a satellite communication system, a high altitude platform station (HAPS) communication system, a non-terrestrial network (nonNTN) system such as an uncrewed aerial vehicle, an integrated communication and navigation (ICaN) system, a global navigation satellite system (GNSS), an ultra-dense low earth orbit satellite communication system, a long term evolution (LTE) system, an LTE frequency division duplex (FDD) system, an LTE time division duplex (TDD) system, a universal mobile telecommunications system (UMTS), a 5th generation (5G) system or a communication system evolved after 5G, vehicle-to-everything (V2X), where V2X may include vehicle-to-network (V2N), vehicle-to-vehicle (V2V), vehicle-to-infrastructure (V2I), vehicle-to-pedestrian (V2P), and the like, a long term evolution-vehicle (LTE-V), the internet of vehicles, machine type communication (MTC), the internet of things (IoT), a long term evolution-machine (LTE-M), and machine-to-machine (M2M).

The following explains terms in embodiments of this application.

1. Reflection device: includes an antenna panel, where the antenna panel includes at least one antenna. The reflection device may be considered as a reflector in a scenario, that is, may reflect a received signal or data (from a network device or a terminal device), and may have a capability of receiving or sending a signal or data (for example, have a baseband processing capability), or may not have a capability of receiving or sending a signal or data (that is, reflect a received signal or data, and does not perform any processing on the signal or data). This is not limited in this application.

It should be understood that the reflection device may alternatively have another name, for example, a reconfigurable intelligent surface (RIS), an intelligent reflecting surface (IRS), a large intelligent surface (LIS), or another name that is not shown in an example. This is not limited in this application. The reflection device may be controlled by a network device when working. For example, the network device may control turning on of a specific antenna and turning off of a specific antenna in an antenna panel of the reflection device. In this case, the reflection device may be considered as a network device. Certainly, the reflection device may also be understood as a terminal device. This is not limited in this application.

The reflection device may include only an electromagnetic device for passive reflection. Therefore, the reflection device may be deployed on devices such as surfaces of various buildings, indoor walls, platforms, roadside billboards, high-speed road signs, and vehicle windows. In addition, a deployed reflection device may be removed or a reflection device is re-deployed at any time based on a requirement of a communication system. That is, the reflection device may be considered as a supplementary device in the existing communication system. Therefore, deploying the reflection device does not affect an existing communication protocol, that is, deploying the reflection device does not need to change an existing communication device, and is compatible with the existing communication device. When working, the reflection device may passively reflect only a received signal, that is, a transmitting unit and a receiving unit may not need to be configured in the reflection device, and a received signal or data does not need to be encoded or decoded. Therefore, compared with the existing communication device (for example, a terminal device and/or a network device), the reflection device has lower complexity, and therefore energy consumption of a wireless communication system can be reduced. The reflection device further provides a variable degree of freedom, and can control an antenna, so that communication quality of a radio link is improved, strength of a wanted signal of a receiving end is enhanced, and channel interference strength is reduced, thereby providing a breakthrough point for implementation of a future intelligent network. In addition, because the reflection device may only need to perform passive reflection, the reflection device may run in a full-duplex mode, thereby improving spectrum efficiency.

2. Port: may be understood as an antenna port, and is defined from a perspective of a receiving end. A port may be considered as an independent antenna channel for the receiving end. The port may be understood as a transmit antenna identified by a receive device, or a transmit antenna that can be identified in space. For example, the transmitting end has four coherent small-spacing physical antennas, and the four physical antennas may be defined as one port. For the receiving end, the four physical antennas are basically the same as one physical antenna in essence. The only difference lies in that the transmitting end can perform dynamic beamforming on the four physical antennas, but can perform only sector beamforming (that is, directional antenna) on the one physical antenna. In addition, for a single-port system, there may be no precoding or codebook in a multiple-input and multiple-output (MIMO) system or the like.

The port is associated with a reference signal (RS). That is, a quantity of ports is related to a quantity of reference signals, and each port sends different reference signals on different physical resources. An actual quantity of physical antennas may be greater than or equal to the quantity of ports, but a mapping relationship between a port and a physical antenna is not fixed, and may be independently implemented by a device manufacturer. For example, one port may be configured for each virtual antenna, each virtual antenna may be a weighted combination of a plurality of (two or more) physical antennas, and each port may correspond to one reference signal. Therefore, each port may be referred to as a port of one reference signal, for example, a channel state information reference signal (CSI-RS) port or a sounding reference signal (SRS) port.

At the transmitting end, a mapping relationship between a physical antenna (or an antenna array element) and a logical port is internally implemented. Generally, the mapping relationship has a specific criterion. For example, non-coherent physical antennas correspond to different ports, which facilitates precoding. Array elements between which a space spacing is greater than 10 wavelengths may be considered as non-coherent antennas. For a carrier that is about 2G, 10 wavelengths are approximately 1.5 meters. Array elements between which a space spacing is less than 0.5 wavelength may be considered as coherent antennas, and the coherent antennas may be mapped to one port for dynamic beamforming.

In conclusion, one port may be understood as one channel, that is, a channel on which the receiving end performs channel measurement. The terminal device needs to perform channel measurement and data demodulation based on a reference signal corresponding to the port.

In an NR system, a transmitter and a receiver track time domain and frequency domain changes of a channel by using a known reference signal. The reference signal may also be referred to as a pilot signal or a reference signal, and is uniformly referred to as a reference signal in this specification. Different reference signals correspond to different resource elements (RE), and have determined amplitudes and phases. In a MIMO system, a transmit antenna (including a virtual antenna and/or a physical antenna) port has an independent channel. A receiving end performs channel measurement on each transmit port based on a reference signal, and may perform data scheduling, link adaptation, and generation of transmission-related configuration information in the MIMO system based on an estimation result.

In an implementation, in an uplink and a downlink, to implement channel measurement in a multi-antenna system, the following reference signals are defined in an NR system: a CSI-RS, an SRS, and a demodulation reference signal (DMRS). The CSI-RS is used to measure downlink channel state information, the SRS is used to estimate an uplink channel, and the DMRS is used to assist in demodulation of a physical downlink shared channel (PDSCH).

For example, when the reference signal is a CSI-RS, 32 ports may be supported.

Regardless of whether code division multiplexing is used (code division multiplexing is to send a plurality of different reference signals on a same physical RE), a quantity of ports is the same as a total quantity of REs required for sending a reference signal. In addition, when a same port sends reference signals on different physical resources, different symbols of a same sequence may be used. Therefore, a larger quantity of ports indicates a larger quantity of required physical REs.

In the NR system, a quantity of ports of reference signals is related to a quantity of physical antennas, and non-coherent physical antennas are defined as different ports. In the 6G technology, a quantity of antennas at a network device end increases, and an RIS device includes a large quantity of antennas to achieve a desired performance gain. Therefore, if a channel measurement technology of the NR system is used, because the quantity of antennas increases, a quantity of ports increases as the quantity of antennas increases, and resource overheads for channel measurement also increase. This results in a decrease in resources used for data transmission, thereby reducing frequency efficiency and a throughput rate of a communication system.

In view of this, an embodiment of this application provides a channel measurement method, to reduce resource overheads for channel measurement.

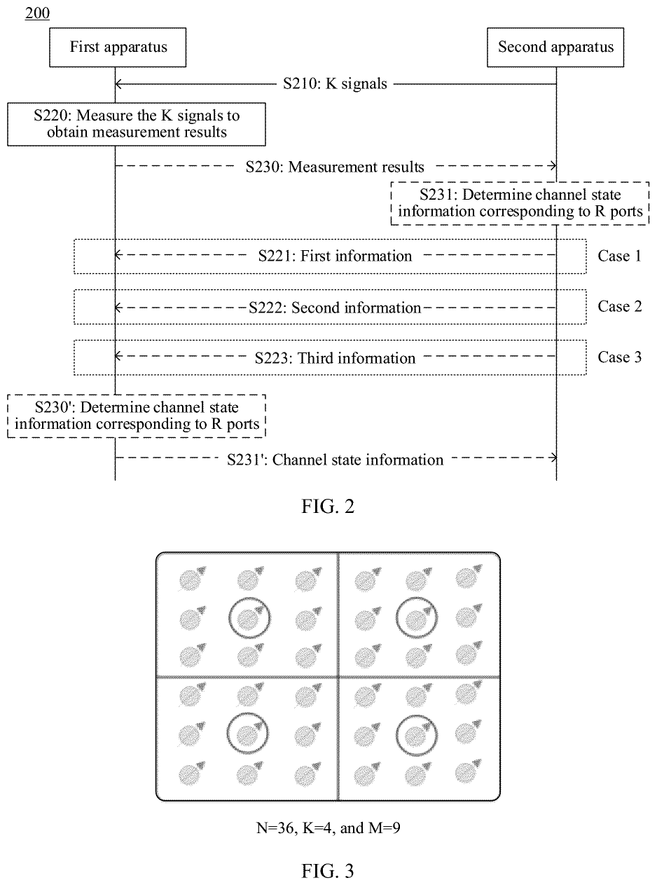

FIG. 2 is an interaction flowchart of a channel measurement method according to an embodiment of this application. The method 200 shown in FIG. 2 includes the following steps:

S210: A second apparatus sends K signals to a first apparatus, where the K signals are in one-to-one correspondence with K ports, and correspondingly, the first apparatus receives the K signals.

It should be understood that the first apparatus and the second apparatus include but are not limited to the following cases: The first apparatus is a terminal device, and the second apparatus is a network device. In this case, the K signals may be used for downlink channel measurement, and may be further used for uplink channel measurement through downlink channel measurement. The first apparatus is a network device, and the second apparatus is a terminal device. In this case, the K signals are used for uplink channel measurement, and may be further used for downlink channel measurement through uplink channel measurement. The first apparatus is a terminal device, and the second apparatus is a terminal device. In this case, the K signals are used for channel measurement between the terminal devices. The first apparatus is a network device, and the second apparatus is a network device. In this case, the K signals are used for channel measurement between the network devices.

For example, the signal may be a reference signal or another signal used for channel measurement, a reference signal used for downlink channel measurement may be a CSI-RS or a DMRS, and a reference signal used for uplink channel measurement may be an SRS. The reference signal is merely an example. This is not limited in this application.

The K signals may be K same signals, or may be K different signals. Alternatively, the K signals may include some same signals and some different signals. This is not limited in this application.

S220: The first apparatus measures the K signals to obtain measurement results, where the measurement results are used to determine channel state information corresponding to R ports, R is greater than or equal to K, and K is greater than or equal to 1.

Optionally, the K ports are ports in the R ports, the K ports and the R ports include at least one same port, or the K ports are different from the R ports.

It should be understood that R may be less than K when the K ports and the R ports include at least one same port, or the K ports are different from the R ports.

In an implementation, optionally, the method 200 further includes the following steps.

S230: The first apparatus sends the measurement results to the second apparatus, and correspondingly, the second apparatus receives the measurement results.

S231: The second apparatus determines, based on the measurement results, the channel state information corresponding to the R ports.

Optionally, the second apparatus determines, based on the measurement results and a correspondence between the K ports and the R ports, the channel state information corresponding to the R ports.

For example, the first apparatus is a terminal device, and the second apparatus is a network device. The network device may estimate channel states of the K ports based on the measurement results, and obtain channel states of the R ports by using a related interpolation or smoothing technology. The interpolation technology includes a constant interpolation and a linear interpolation. The constant interpolation refers to replacing channel frequency response values (corresponding to ports other than the K ports) at adjacent data locations with known channel frequency response values (corresponding to the K ports) at pilot locations. The linear interpolation algorithm refers to calculating channel frequency response values (corresponding to the R ports) at other locations by using channel frequency response values (corresponding to the K ports) of two adjacent reference signals. In the interpolation calculation process, the channel frequency response values of the R ports may be determined based on the correspondence between the K ports and the R ports and the channel frequency response values of the K ports. The smoothing technology refers to averaging a plurality of observed values at adjacent moments to obtain a measurement result at a current moment, for example, averaging channel measurement results of the K ports to obtain the channel state information of the R ports. The R ports may be all ports of the second apparatus end, or may be some ports of the second apparatus end. This is not limited in this application. In another implementation, optionally, the method 200 further includes the following steps:

S230′: The first apparatus determines, based on the measurement results, the channel state information corresponding to the R ports.

Optionally, the first apparatus determines, based on the measurement results and the correspondence between the K ports and the R ports, the channel state information corresponding to the R ports.

S231′: The first apparatus sends the channel state information corresponding to the R ports to the second apparatus, and correspondingly, the second apparatus receives the channel state information corresponding to the R ports.

It should be understood that S230 and S231 are an implementation different from S230′ and S231′. In an actual channel measurement process, one of the two implementations may be selected. This is not limited in this application.

In S231 and S230′, that the first apparatus or the second apparatus determines, based on the measurement results and the correspondence between the K ports and the R ports, the channel state information of the R ports may be classified into the following cases:

### Case 1

In an implementation, the K signals correspond to a first antenna subarray set of the second apparatus, or the K signals correspond to a second antenna subarray set of a third apparatus, where the first antenna subarray set includes at least one antenna subarray, the second antenna subarray set includes at least one antenna subarray, and the antenna subarray includes at least one antenna.

Alternatively, the K signals correspond to a first antenna subarray set of the second apparatus and a second antenna subarray set of a third apparatus.

For example, the K signals correspond to K0 antenna subarrays (the first antenna subarray set includes the K0 antenna subarrays) of the second apparatus, or the K signals correspond to K0 antenna subarrays (the second antenna subarray set includes the K0 antenna subarrays) of the third apparatus, where K0 is greater than or equal to K, one antenna subarray corresponds to one reference signal, and one reference signal may correspond to at least one antenna subarray.

Alternatively, the K signals correspond to K0 antenna subarrays of the second apparatus and K0 antenna subarrays of a third apparatus.

Alternatively, the K signals correspond to K1 antenna subarrays (a first antenna subarray set includes the K1 antenna subarrays) of the second apparatus and K2 antenna subarrays (a second antenna subarray set includes the K2 antenna subarrays) of a third apparatus, where the K1 antenna subarrays and the K2 antenna subarrays may include K1*K2 combinations, each combination corresponds to one of the K signals, and K may be equal to K1*K2. This is not limited in this application.

It should be understood that, in this implementation, the first apparatus may be a terminal device, the second apparatus may be a network device, and the third apparatus may be a reflection device.

In another implementation, the K signals correspond to a first antenna subarray set of the first apparatus, or the K signals correspond to a second antenna subarray set of a third apparatus, where the first antenna subarray set includes at least one antenna subarray, the second antenna subarray set includes at least one antenna subarray, and the antenna subarray includes at least one antenna.

Alternatively, the K signals correspond to a first antenna subarray set of the first apparatus and a second antenna subarray set of a third apparatus.

For example, the K signals correspond to K0 antenna subarrays (a first antenna subarray set includes the K0 antenna subarrays) of the first apparatus, or the K signals correspond to K0 antenna subarrays (a second antenna subarray set includes the K0 antenna subarrays) of the third apparatus, where K0 is greater than or equal to K, one antenna subarray corresponds to one reference signal, and one reference signal may correspond to at least one antenna subarray.

Alternatively, the K signals correspond to K0 antenna subarrays of the first apparatus and K0 antenna subarrays of a third apparatus.

Alternatively, the K signals correspond to K1 antenna subarrays (a first antenna subarray set includes the K1 antenna subarrays) of the first apparatus and K2 antenna subarrays (a second antenna subarray set includes the K2 antenna subarrays) of a third apparatus, where the K1 antenna subarrays and the K2 antenna subarrays may include K1*K2 combinations, each combination corresponds to one of the K signals, and K may be equal to K1*K2. This is not limited in this application.

It should be understood that, in this implementation, the first apparatus may be a network device, the second apparatus may be a terminal device, and the third apparatus may be a reflection device.

Optionally, the first apparatus or the second apparatus determines, based on the measurement results and first information, the channel state information of the R ports. The first information includes at least one of the following: quantity information of an antenna subarray in the first antenna subarray set, quantity information (for example, a value of K, K0, K1, or K2) of an antenna subarray in the second antenna subarray set, quantity information of an antenna included in each antenna subarray, and information about a correspondence between the antenna subarray and antennas for sending the K signals.

Optionally, the first information is predefined or preconfigured on the first apparatus or the second apparatus.

If the second apparatus is a network device, the first apparatus is a terminal device, and the first information is not preconfigured on the terminal device, to enable the terminal device to determine, based on the measurement results and the correspondence between the K ports and the R ports, the channel state information corresponding to the R ports, the first apparatus needs to obtain the correspondence.

Optionally, the method 200 further includes the following step:

S221: The second apparatus sends first information to the first apparatus, where the first information is used to determine the correspondence between the K ports and the R ports, and correspondingly, the first apparatus receives the first information.

Optionally, the first information is carried in downlink control information (DCI) or radio resource control (RRC) signaling.

For example, in a transmission scenario in which there is no reflection device or the reflection device is turned off, an antenna included in an antenna panel of the network device may be classified into an antenna subarray. If the network device estimates channel states of R ports based on measurement results of K reference signals, that is, S231, a classification manner (first information) of the antenna included in the antenna panel of the network device may not need to be indicated to the terminal device. If the terminal device estimates channel states of R ports based on measurement results of K reference signals and sends the channel states to the network device, that is, S230′, a classification manner of the antenna included in the antenna panel of the network device needs to be indicated to the terminal device, so that the terminal device can perform channel measurement based on the classification manner and the measurement results. In this scenario, the K reference signals correspond to K0 antenna subarrays of the network device.

For example, in a transmission scenario in which the reflection device is turned on, if a quantity of antennas at the network device end is small and no classification is needed, an antenna included in an antenna panel of the reflection device may be classified into an antenna subarray. If the network device estimates channel states of R ports based on measurement results of K reference signals, that is, S231, a classification manner (first information) of the antenna included in the antenna panel of the reflection device may not need to be indicated to the terminal device. If the terminal device estimates channel states of R ports based on measurement results of K reference signals and sends the channel states to the network device, that is, S230′, a classification manner of the antenna included in the antenna panel of the reflection device to the terminal device, so that the terminal device can perform channel measurement based on the classification manner and the measurement results. In this scenario, the K reference signals correspond to K0 antenna subarrays of the reflection device.

For example, in a transmission scenario in which the reflection device is turned on, antennas included in antenna panels of both the reflection device and the network device are respectively classified into antenna subarrays. If the network device estimates channel states of R ports based on measurement results of K reference signals, that is, S231, classification manners (first information) of the antenna panels of the reflection device and the network device may not need to be indicated to the terminal device. If the terminal device estimates channel states of R ports based on measurement results of K reference signals and sends the channel states to the network device, that is, S230′, classification manners of the antenna panels of the reflection device and the network device need to be indicated to the terminal device, so that the terminal device can perform channel measurement based on the classification manners and the measurement results.

It is assumed that in this scenario, the K reference signals, K0 antenna subarrays of the reflection device, and K0 antenna subarrays of the network device correspond to each other. K=3=K0, the K reference signals include a reference signal #1, a reference signal #2, and a reference signal #3, K antenna subarrays of the reflection device include an antenna subarray #A1, an antenna subarray #A2, and an antenna subarray #A3, and K antenna subarrays of the network device include an antenna subarray #B1, an antenna subarray #B2, and an antenna subarray #B3. The reference signal #1 corresponds to the antenna subarray #A1 and the antenna subarray #B1, the reference signal #2 corresponds to the antenna subarray #A2 and the antenna subarray #B2, and the reference signal #3 corresponds to the antenna subarray #A3 and the antenna subarray #B3.

It is assumed that in this scenario, the K reference signals correspond to K1 antenna subarrays of the reflection device and K2 antenna subarrays of the network device, where K=K1*K2. K=4, K1=K2=2, the K reference signals include a reference signal #1, a reference signal #2, a reference signal #3, and a reference signal #4, the K1 antenna subarrays of the reflection device include an antenna subarray #A1 and an antenna subarray #A2, and the K2 antenna subarrays of the network device include an antenna subarray #B1 and an antenna subarray #B2. The reference signal #1 corresponds to the antenna subarray #A1 and the antenna subarray #B1, the reference signal #2 corresponds to the antenna subarray #A1 and the antenna subarray #B2, the reference signal #3 corresponds to the antenna subarray #A2 and the antenna subarray #B1, and the reference signal #4 corresponds to the antenna subarray #A2 and the antenna subarray #B2. The foregoing correspondence is merely an example. This is not limited in this application.

The following describes the classification method of the antenna panel of the network device in Case 1. The classification method of the antenna panel of the reflection device is similar to the classification method of the antenna panel of the network device. For details, refer to the classification method of the antenna panel of the network device. The details are not described again.

In an implementation, one antenna subarray corresponds to one port, and one port corresponds to one signal. In other words, a quantity of signals may be equal to a quantity of antenna subarrays. The antenna panel of the network device includes N antennas, and the N antennas are classified into K antenna subarrays. Each antenna subarray includes M antennas, and a dimension of each antenna subarray is M=Mx*My, where Mx is a quantity of antennas included in each antenna subarray in a horizontal direction, and My is a quantity of antennas included in each antenna subarray in a vertical direction.

For example, if a quantity K of antenna subarrays is fixed, M=N/K. As shown in FIG. 3, N=36, K=4, and a quantity of antennas included in each antenna subarray is: M=N/K=36/4=9. If the antenna subarray is a square array, M=Mx*My=3*3. When K is small, this manner can effectively control transmission resource overheads of the reference signal.

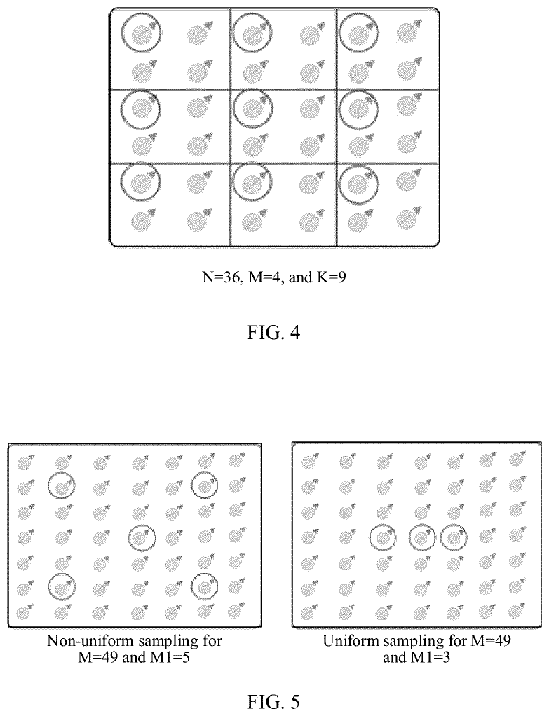

For example, if a quantity M of antennas in each antenna subarray is fixed, K=N/M. As shown in FIG. 4, N=36, M=4, and a quantity of antenna subarrays is: K=N/M=36/4=9. If the antenna subarray is a square array, M=Mx*My=2*2. When M is small, this manner can effectively ensure channel measurement performance.

The classification manner of the antenna subarray is a regular classification manner, that is, each antenna subarray has a same shape and dimension. Certainly, the antenna panel may be classified into an irregular antenna subarray. This is not limited in this application.

It should be understood that the correspondence between the antenna subarray and the antennas used by the second apparatus to send the K signals is locations or distribution of the antennas for sending the K signals in the antenna subarray. The antenna that sends the K signals is a physical antenna that is actually enabled during sending, and the antenna subarray is an antenna subarray in a first antenna subarray set and/or a second antenna subarray set.

Each of the K signals corresponds to one port, one port corresponds to one logical (virtual) antenna, one logical (virtual) antenna corresponds to one or more physical antennas, and a physical antenna for sending each signal may correspond to all physical antennas in an antenna subarray, or correspond to some physical antennas in an antenna subarray.

It is assumed that a physical antenna for sending each signal corresponds to one physical antenna in an antenna subarray, as shown in FIG. 3. That is, the physical antenna for sending each signal corresponds to an antenna in a circle. In addition, if all nine antennas in each antenna subarray are non-irrelevant antennas, according to a common mapping rule between a logical port and a physical antenna, nine antennas actually need to be estimated in each antenna subarray, and correspond to nine ports. The network device or the terminal device reckons, according to a corresponding recovery algorithm and based on a channel measurement result corresponding to an antenna in each antenna subarray circle, channel state information of all ports (that is, the nine ports) corresponding to each antenna subarray.

FIG. 5 shows a case in which a physical antenna for sending each signal corresponds to a plurality of physical antennas in an antenna subarray. An antenna in a circle is an antenna corresponding to a port corresponding to the antenna subarray, and the antenna subarray includes 49 physical antennas. FIG. 5 shows two manners of mapping between a physical antenna for sending each signal and a physical antenna in an antenna subarray. One is non-uniform sampling in an antenna subarray (a quantity of physical antennas in the antenna subarray that correspond to the physical antenna for sending each signal is M1=5), and the other is uniform sampling in an antenna subarray (a quantity of physical antennas in the antenna subarray that correspond to the physical antenna for sending each signal is M1=3).

In Case 1, the network device or the terminal device needs to know at least one of a dimension of each antenna subarray and a mapping relationship between a physical antenna for sending each signal and a physical antenna in an antenna subarray (that is, first information). As shown in FIG. 3, four antenna subarrays correspond to four ports, and each port corresponds to one signal. After receiving four signals, the receiving end recovers channel state information on all ports in each antenna subarray based on the first information and measurement results of the four signals and according to a related algorithm.

### Case 2

In an implementation, the K signals correspond to at least one of the following: a first antenna set that is determined by the second apparatus and that is used for channel measurement, and a second antenna set that is determined by a third apparatus and that is used for channel measurement.

For example, the K signals correspond to K4 antennas (the first antenna set includes the K4 antennas) of the second apparatus, or the K signals correspond to K4 antennas (the second antenna set includes the K4 antennas) of the third apparatus, where K4 is greater than or equal to K, one antenna corresponds to one reference signal, and one reference signal may correspond to at least one antenna.

Alternatively, the K signals correspond to K4 antennas of the second apparatus and K4 antennas of a third apparatus.

Alternatively, the K signals correspond to K5 antennas (a first antenna set includes the K5 antennas) of the second apparatus and K6 antennas (a second antenna set includes the K6 antennas) of a third apparatus, where the K5 antennas and the K6 antennas may include K5*K6 combinations, each combination corresponds to one of the K reference signals, and K may be equal to K5*K6. This is not limited in this application.

It should be understood that, in this implementation, the first apparatus may be a terminal device, the second apparatus may be a network device, and the third apparatus may be a reflection device.

In another implementation, the K signals correspond to at least one of the following: a first antenna set that is determined by the first apparatus and that is used for channel measurement, and a second antenna set that is determined by a third apparatus and that is used for channel measurement.

For example, the K signals correspond to K4 antennas (the first antenna set includes the K4 antennas) of the first apparatus, or the K signals correspond to K4 antennas (the second antenna set includes the K4 antennas) of the third apparatus, where K4 is greater than or equal to K, one antenna corresponds to one reference signal, and one reference signal may correspond to at least one antenna.

Alternatively, the K signals correspond to K4 antennas of the first apparatus and K4 antennas of a third apparatus.

Alternatively, the K signals correspond to K5 antennas (a first antenna set includes the K5 antennas) of the first apparatus and K6 antennas (a second antenna set includes the K6 antennas) of a third apparatus, where K=K5*K6, that is, the K5 antennas and the K6 antennas may include K5*K6 combinations, each combination corresponds to one of the K reference signals, and K may be equal to K5*K6. However, this is not limited in this application.

It should be understood that, in this implementation, the first apparatus may be a network device, the second apparatus may be a terminal device, and the third apparatus may be a reflection device.

Optionally, the first apparatus or the second apparatus determines, based on the measurement results and second information, the channel state information of the R ports. The second information includes at least one of the following: information about a distance from an antenna in the first antenna set to an antenna panel center, phase information of the antenna in the first antenna set, information about a distance from an antenna in the second antenna set to an antenna panel center, and phase information of the antenna in the second antenna set.

For example, a phase may be an angle between a horizontal direction of an antenna panel and a connection line between an antenna and an antenna panel center, or an angle between a vertical direction of an antenna panel and a connection line between an antenna and an antenna panel center. This is not limited in this application.

Optionally, the terminal device determines the correspondence between the K ports and the R ports based on the second information.

Optionally, the second information is predefined or preconfigured on the first apparatus or the second apparatus.

For example, if the second apparatus is a network device, the first apparatus is a terminal device, and the second information is not preconfigured on the terminal device, to enable the terminal device to determine, based on the measurement results and the correspondence between the K ports and the R ports, the channel state information corresponding to the R ports, the first apparatus needs to obtain the correspondence.

Optionally, the method 200 further includes the following step:
S222: The second apparatus sends second information to the first apparatus, where the second information is used to determine the correspondence between the K ports and the R ports, and correspondingly, the first apparatus receives the second information.

Optionally, the second information is carried in DCI or RRC signaling.

In an implementation, when indicating, to the first apparatus, a distance from the antenna in the first antenna set and/or the second antenna set to the antenna panel center, the second apparatus may explicitly or implicitly indicate a distance from each antenna in the first antenna set and/or the second antenna set to the antenna panel center; or may explicitly or implicitly indicate a distance d0 from an antenna in the first antenna set and/or the second antenna set to the antenna panel center and a difference between d0 and a distance from another antenna to the antenna panel center.

In an implementation, when indicating, to the first apparatus, a phase of the antenna in the first antenna set and/or the second antenna set, the second apparatus may explicitly or implicitly indicate a phase of each antenna in the first antenna set and/or the second antenna set; or may explicitly or implicitly indicate a phase θ0 of an antenna in the first antenna set and/or the second antenna set and a difference between θ0 and a phase of another antenna.

For example, in a transmission scenario in which there is no reflection device or the reflection device is turned off, K4 antennas may be determined from antennas included in an antenna panel of the network device, to transmit the K reference signals. If the network device estimates channel states of the R ports based on measurement results of the K reference signals, that is, S231, a manner (second information) in which the network device determines the K4 antennas from the antennas at the network device end may not need to be indicated to the terminal device. If the terminal device estimates channel states of the R ports based on measurement results of the K reference signals and sends the channel states to the network device, that is, S230′, a manner in which the network device determines the K4 antennas from the antennas at the network device end needs to be indicated to the terminal device, so that the terminal device can perform channel measurement based on the determining manner and the measurement results. In this scenario, the K reference signals correspond to the K4 antennas of the network device.

For example, in a transmission scenario in which the reflection device is turned on, if a quantity of antennas at the network device end is small, and antenna selection does not need to be performed at the network device end, K4 antennas may be determined from antennas included in an antenna panel of the reflection device, to transmit the K reference signals. If the network device estimates channel states of the R ports based on measurement results of the K reference signals, that is, S231, a manner (second information) of determining the K4 antennas from the antennas at the reflection device end may not need to be indicated to the terminal device. If the terminal device estimates channel states of the R ports based on measurement results of the K reference signals and sends the channel states to the network device, that is, S230′, a manner of determining the K4 antennas from the antennas at the reflection device end needs to be indicated to the terminal device, so that the terminal device can perform channel measurement based on the determining manner and the measurement results. In this scenario, the K reference signals correspond to the K4 antennas of the reflection device.

For example, in a transmission scenario in which the reflection device is turned on, when antennas at both the reflection device end and the network device end are selected, K4 or K5 antennas may be determined from antennas at the network device end, and K4 or K6 antennas may be determined from antennas included in an antenna panel of the reflection device, to transmit the K reference signals. If the network device estimates channel states of the R ports based on measurement results of the K reference signals, that is, S231, a manner (second information) of determining the antennas from the antennas at the network device end and the reflection device end may not need to be indicated to the terminal device. If the terminal device estimates channel states of the R ports based on measurement results of the K reference signals and sends the channel states to the network device, that is, S230′, the manner of determining the antennas from the antennas at the network device end and the reflection device end needs to be indicated to the terminal device, so that the terminal device can perform channel measurement based on the determining manner and the measurement results.

It is assumed that in this scenario, the K reference signals correspond to the K4 antennas of the reflection device and the K4 antennas of the network device. K=3=K4, the K reference signals include a reference signal #1, a reference signal #2, and a reference signal #3, the K4 antennas of the reflection device include an antenna #C1, an antenna #C2, and an antenna #C3, and the K4 antennas of the network device include an antenna #D1, an antenna #D2, and an antenna #D3. The reference signal #1 corresponds to the antenna #C1 and the antenna #D1, the reference signal #2 corresponds to the antenna #C2 and the antenna #D2, and the reference signal #3 corresponds to the antenna #C3 and the antenna #D3.

It is assumed that in this scenario, the K reference signals correspond to the K5 antennas of the network device and the K6 antennas of the reflection device. K=4, K5=K6=2, the K reference signals include a reference signal #1, a reference signal #2, a reference signal #3, and a reference signal #4, the K5 antennas selected by the network device end include an antenna #C1 and an antenna #C2, and the K6 antennas selected by the reflection device end include an antenna #D1 and an antenna #D2. The reference signal #1 corresponds to the antenna #C1 and the antenna #D1, the reference signal #2 corresponds to the antenna #C1 and the antenna #D2, the reference signal #3 corresponds to the antenna #C2 and the antenna #D1, and the reference signal #4 corresponds to the antenna #C2 and the antenna #D2. The foregoing correspondence is merely an example. This is not limited in this application.

The following describes the manner of determining the antenna used for channel measurement from the network device end. The manner of determining the antenna used for channel measurement from the reflection device end is similar to the manner of determining the antenna used for channel measurement from the network device end. For details, refer to the manner of determining the antenna from the network device end. The details are not described again.

In an implementation, an antenna that needs to be estimated is determined from an antenna panel center based on a polar coordinate system, where a distance between the determined antenna and the antenna panel center is d, and an angle between a horizontal direction of an antenna panel and a connection line between the determined antenna and the antenna panel center is 0.

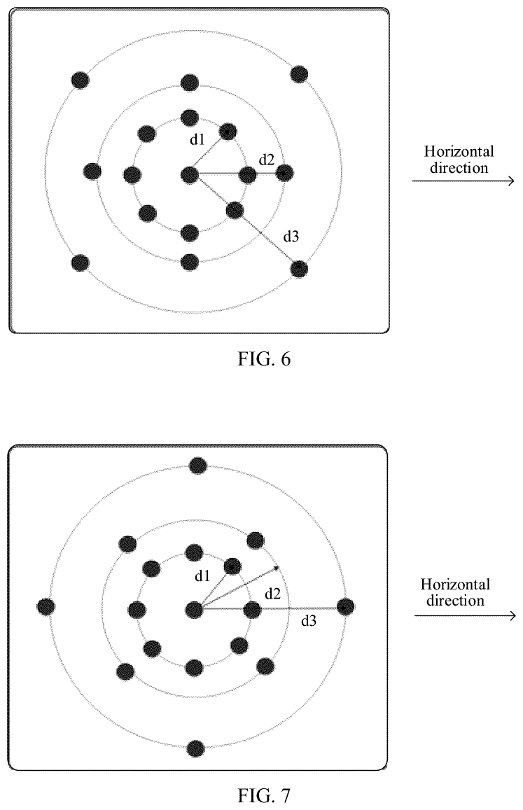

For example, as shown in FIG. 6, there are eight determined antennas whose distances from the antenna panel center are d1, there are four determined antennas whose distances from the antenna panel center are d2, and there are four determined antennas whose distances from the antenna panel center are d3. For the antennas whose distances from the antenna panel center are d1, an angle between a horizontal direction of an antenna panel and a connection line between an initial antenna and the antenna panel center is 45 degrees, and an angle interval between connection lines between different antennas and the antenna panel center is 45 degrees. For the antennas whose distances from the antenna panel center are d2, an angle between the horizontal direction of the antenna panel and a connection line between an initial antenna and the antenna panel center is 0 degrees, and an angle interval between connection lines between different antennas and the antenna panel center is 90 degrees. For the antennas whose distances from the antenna panel center are d3, an angle between the horizontal direction of the antenna panel and a connection line between an initial antenna and the antenna panel center is −45 degrees, and an angle interval between connection lines between different antennas and the antenna panel center is 90 degrees.

For example, as shown in FIG. 7, there are eight determined antennas whose distances from the antenna panel center are d1, there are four determined antennas whose distances from the antenna panel center are d2, and there are four determined antennas whose distances from the antenna panel center are d3. For the antennas whose distances from the antenna panel center are d1, an angle between a horizontal direction of an antenna panel and a connection line between an initial antenna and the antenna panel center is 45 degrees, and an angle interval between connection lines between different antennas and the antenna panel center is 45 degrees. For the antennas whose distances from the antenna panel center are d2, an angle between the horizontal direction of the antenna panel and a connection line between an initial antenna and the antenna panel center is 45 degrees, and an angle interval between connection lines between different antennas and the antenna panel center is 90 degrees. For the antennas whose distances from the antenna panel center are d3, an angle between the horizontal direction of the antenna panel and a connection line between an initial antenna and the antenna panel center is 0 degrees, and an angle interval between connection lines between different antennas and the antenna panel center is 90 degrees.

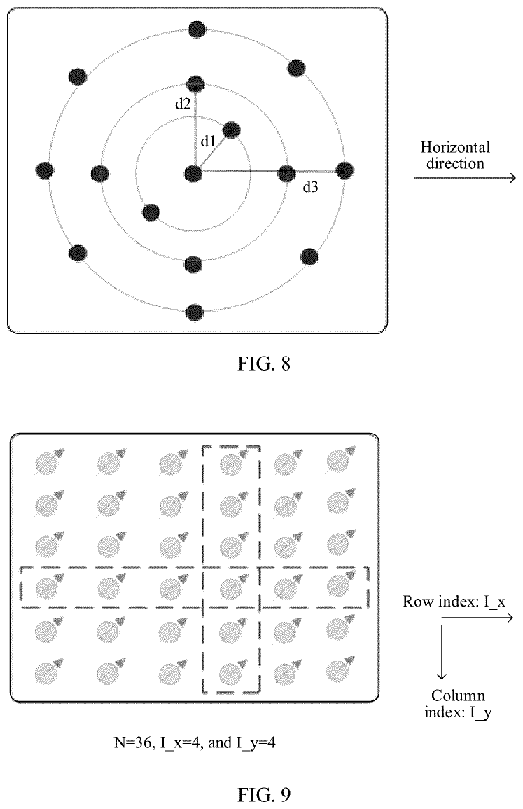

For example, as shown in FIG. 8, there are two determined antennas whose distances from the antenna panel center are d1, there are four determined antennas whose distances from the antenna panel center are d2, and there are eight determined antennas whose distances from the antenna panel center are d3. For the antennas whose distances from the antenna panel center are d1, an angle between a horizontal direction of an antenna panel and a connection line between an initial antenna and the antenna panel center is 45 degrees, and an angle interval between connection lines between different antennas and the antenna panel center is 180 degrees. For the antennas whose distances from the antenna panel center are d2, an angle between the horizontal direction of the antenna panel and a connection line between an initial antenna and the antenna panel center is 0 degrees, and an angle interval between connection lines between different antennas and the antenna panel center is 90 degrees. For the antennas whose distances from the antenna panel center are d3, an angle between the horizontal direction of the antenna panel and a connection line between an initial antenna and the antenna panel center is 0 degrees, and an angle interval between connection lines between different antennas and the antenna panel center is 45 degrees.

In Case 2, the network device or the terminal device needs to know locations of the determined antennas and a correspondence between ports of the determined antennas and the R ports, so that the channel state information of the R ports can be recovered based on the measurement results of the K reference signals and according to a related algorithm (refer to related descriptions in S231. Details are not described again).

### Case 3

In an implementation, the K signals correspond to at least one of the following: a first antenna set that is determined by the second apparatus and that is used for channel measurement, and a second antenna set that is determined by a third apparatus and that is used for channel measurement.

For example, the K signals correspond to K4 antennas (the first antenna set includes the K4 antennas) of the second apparatus, or the K signals correspond to K4 antennas (the second antenna set includes the K4 antennas) of the third apparatus, where K4 is greater than or equal to K, one antenna corresponds to one reference signal, and one reference signal may correspond to at least one antenna.

Alternatively, the K signals correspond to K4 antennas of the second apparatus and K4 antennas of a third apparatus.

Alternatively, the K signals correspond to K5 antennas (a first antenna set includes the K5 antennas) of the second apparatus and K6 antennas (a second antenna set includes the K6 antennas) of a third apparatus, where the K5 antennas and the K6 antennas may include K5*K6 combinations, each combination corresponds to one of the K reference signals, and K may be equal to K5*K6. This is not limited in this application.

It should be understood that, in this implementation, the first apparatus may be a terminal device, the second apparatus may be a network device, and the third apparatus may be a reflection device.

In another implementation, the K signals correspond to at least one of the following: a first antenna set that is determined by the first apparatus and that is used for channel measurement, and a second antenna set that is determined by a third apparatus and that is used for channel measurement.

For example, the K signals correspond to K4 antennas (the first antenna set includes the K4 antennas) of the first apparatus, or the K signals correspond to K4 antennas (the second antenna set includes the K4 antennas) of the third apparatus, where K4 is greater than or equal to K, one antenna corresponds to one reference signal, and one reference signal may correspond to at least one antenna.

Alternatively, the K signals correspond to K4 antennas of the first apparatus and K4 antennas of a third apparatus.

Alternatively, the K signals correspond to K5 antennas (a first antenna set includes the K5 antennas) of the first apparatus and K6 antennas (a second antenna set includes the K6 antennas) of a third apparatus, where K=K5*K6, that is, the K5 antennas and the K6 antennas may include K5*K6 combinations, each combination corresponds to one of the K reference signals, and K may be equal to K5*K6. However, this is not limited in this application.

It should be understood that, in this implementation, the first apparatus may be a network device, the second apparatus may be a terminal device, and the third apparatus may be a reflection device.

Optionally, the first apparatus or the second apparatus determines, based on the measurement results and third information, the channel state information of the R ports. The third information includes at least one of the following: row information of an antenna in the first antenna set in a horizontal direction of an antenna panel, column information of the antenna in the first antenna set in a vertical direction of the antenna panel, row information of an antenna in the second antenna set in a horizontal direction of an antenna panel, and column information of the antenna in the second antenna set in a vertical direction of the antenna panel.

Optionally, the terminal device determines the correspondence between the K ports and the R ports based on the third information.

Optionally, the third information is predefined or preconfigured on the first apparatus or the second apparatus.

For example, if the second apparatus is a network device, the first apparatus is a terminal device, and the third information is not preconfigured on the terminal device, to enable the terminal device to determine, based on the measurement results and the correspondence between the K ports and the R ports, the channel state information corresponding to the R ports, the first apparatus needs to obtain the correspondence.

Optionally, the method 200 further includes the following step:
S223: The second apparatus sends third information to the first apparatus, where the third information is used to determine the correspondence between the K ports and the R ports, and correspondingly, the first apparatus receives the third information.

Optionally, the third information is carried in DCI or RRC signaling.

In an implementation, when indicating, to the first apparatus, the antenna in the first antenna set and/or the second antenna set, the second apparatus may indicate a location of the antenna in the first antenna set and/or the second antenna set on the antenna panel by using a row index and a column index of the antenna on the antenna panel. Consecutive antennas (for example, indicating a start location and an end location) or inconsecutive antennas (for example, indicating a start location and an interval) may be selected in a row/column, or inconsecutive antennas may be selected in a row or column direction based on a bitmap.

For example, in a transmission scenario in which there is no reflection device or the reflection device is turned off, K4 antennas may be determined from antennas included in an antenna panel of the network device, to transmit the K reference signals. If the network device estimates channel states of the R ports based on measurement results of the K reference signals, that is, S231, a manner (third information) in which the network device determines the K4 antennas from the antennas at the network device end may not need to be indicated to the terminal device. If the terminal device estimates channel states of the R ports based on measurement results of the K reference signals and sends the channel states to the network device, that is, S230′, a manner in which the network device determines the K4 antennas from the antennas at the network device end needs to be indicated to the terminal device, so that the terminal device can perform channel measurement based on the determining manner and the measurement results. In this scenario, the K reference signals correspond to the K4 antennas of the network device.

For example, in a transmission scenario in which the reflection device is turned on, if a quantity of antennas at the network device end is small, and antenna selection does not need to be performed at the network device end, K4 antennas may be determined from antennas included in an antenna panel of the reflection device, to transmit the K reference signals. If the network device estimates channel states of the R ports based on measurement results of the K reference signals, that is, S231, a manner (third information) of determining the K4 antennas from the antennas at the reflection device end may not need to be indicated to the terminal device. If the terminal device estimates channel states of the R ports based on measurement results of the K reference signals and sends the channel states to the network device, that is, S230′, a manner of determining the K4 antennas from the antennas at the reflection device end needs to be indicated to the terminal device, so that the terminal device can perform channel measurement based on the determining manner and the measurement results. In this scenario, the K reference signals correspond to the K4 antennas of the reflection device.

For example, in a transmission scenario in which the reflection device is turned on, when antennas at both the reflection device end and the network device end are selected, K4 or K5 antennas may be determined from antennas at the network device end, and K4 or K6 antennas may be determined from antennas included in an antenna panel of the reflection device, to transmit the K reference signals. If the network device estimates channel states of the R ports based on measurement results of the K reference signals, that is, S231, a manner (third information) of determining the antennas from the antennas at the network device end and the reflection device end may not need to be indicated to the terminal device. If the terminal device estimates channel states of the R ports based on measurement results of the K reference signals and sends the channel states to the network device, that is, S230′, the manner of determining the antennas from the antennas at the network device end and the reflection device end needs to be indicated to the terminal device, so that the terminal device can perform channel measurement based on the determining manner and the measurement results. In this scenario, for a correspondence among the reference signal, the antenna of the reflection device, and the antenna of the network device, refer to the description in Case 2. Details are not described herein again.

The following describes the manner of determining the antenna used for channel measurement from the network device end. The manner of determining the antenna used for channel measurement from the reflection device end is similar to the manner of determining the antenna used for channel measurement from the network device end. For details, refer to the manner of determining the antenna from the network device end. The details are not described again.

In an implementation, when antennas that need to be estimated are determined from an antenna panel center in a horizontal direction (row) and a vertical direction (column), a row/column index may be first determined in the horizontal/vertical direction, and then all or some antennas in the row/column are determined. When the antennas in the row/column are determined, selection may be performed continuously or at an interval, or selection may be performed based on a bitmap (in the bitmap, a location 1 indicates selection, and a location 0 indicates no selection, or vice versa).

For example, as shown in FIG. 9, the determined antennas are located in the fourth row and the fourth column of the antenna panel, and all antennas in the row and the column are selected.

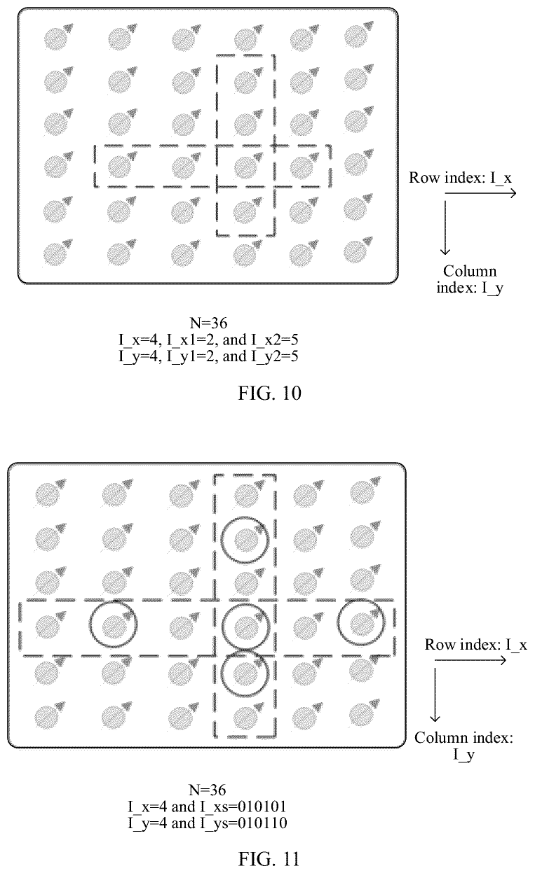

For example, as shown in FIG. 10, the determined antennas are located in the fourth row and the fourth column of the antenna panel, all antennas whose start location is I_x1=2 (the fourth row and the second column) and end location is I_x2=5 (the fourth row and the fifth column) in the fourth row are selected, and all antennas whose start location is I_y1=2 (the fourth column and the second row) and end location is I_y2=5 (the fourth column and the fifth row) in the fourth column are selected.

For example, as shown in FIG. 11, the determined antennas are located in the fourth row and the fourth column of the antenna panel, antennas whose bits are 1 in a bitmap 010101 corresponding to the fourth row are selected, and antennas whose bits are 1 in a bitmap 010110 corresponding to the fourth column are selected.

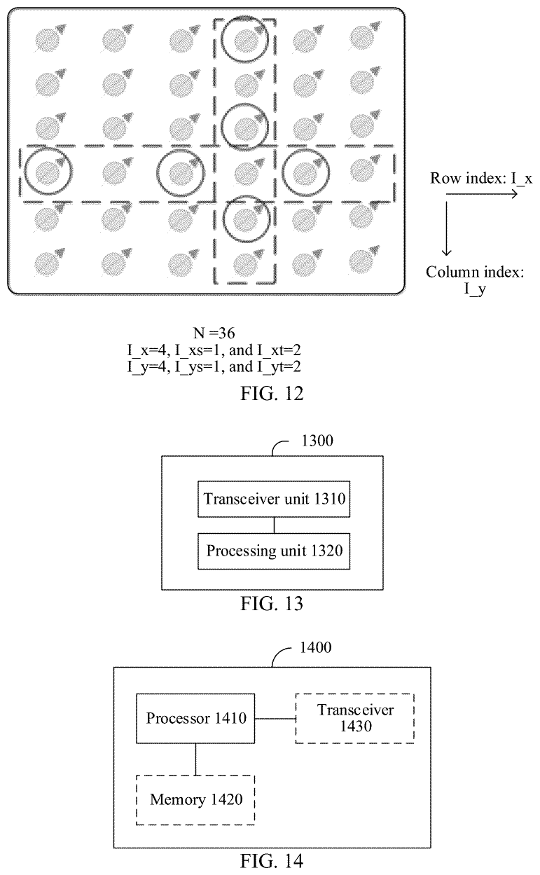

For example, as shown in FIG. 12, the determined antennas are located in the fourth row and the fourth column of the antenna panel, antennas whose start location is 1_xs=1 (the fourth row and the first column) and sampling interval is 1_xt=2 in the fourth row are selected, and antennas whose start location is l_ys=1 (the fourth column and the first row) and sampling interval is l_yt=2 in the column are selected.

In Case 3, the network device or the terminal device needs to know locations of the determined antennas and a correspondence between ports of the determined antennas and the R ports, so that the channel state information of the R ports can be recovered based on the measurement results of the K reference signals and according to a related algorithm (refer to related descriptions in S231. Details are not described again).

The steps in the dashed lines in the foregoing flowchart are optional steps, and a sequence of the steps is determined based on internal logic of the method. Sequence numbers shown in the foregoing flowchart are merely examples, and do not limit a sequence of the steps in this application.

It should be further understood that the methods provided in embodiments of this application may be used separately, or may be used in combination. This is not limited in this application. Various implementations provided in embodiments of this application may be used separately, or may be used in combination. This is not limited in this application.

It should be understood that the term “and/or” in this application describes only an association relationship between associated objects and represents that three relationships may exist. For example, A and/or B may represent the following three cases: Both A and B exist, only A exists, and only B exists, where A and B may be singular or plural. In addition, the character “/” in this specification usually indicates an “or” relationship between the associated objects, or may indicate an “and/or” relationship. For details, refer to the context for understanding.

In this application, that A corresponds to B and C may be understood as that A corresponds to B and A corresponds to C.

In this application, “at least one item (piece)” means one or more items (pieces), and “at least two items (pieces)” and “a plurality of items (pieces)” refer to two or more items (pieces). “At least one of the following items (pieces)” or a similar expression thereof refers to any combination of these items, including any combination of singular items (pieces) or plural items (pieces). For example, at least one of a, b, or c may indicate a, b, c, a and b, a and c, b and c, or a, b, and c, where a, b, and c may be singular or plural.

It should be noted that, an execution body shown in FIG. 2 is merely an example, and the execution body may alternatively be a chip, a chip system, or a processor that supports the execution body in implementing the method shown in FIG. 2. This is not limited in this application.

The foregoing describes the method embodiments in embodiments of this application with reference to the accompanying drawings, and the following describes apparatus embodiments in embodiments of this application. It may be understood that the descriptions of the method embodiments and the descriptions of the apparatus embodiments may correspond to each other. Therefore, for a part that is not described, refer to the foregoing method embodiments.

It may be understood that in the foregoing method embodiments, the method and the operation implemented by the first apparatus may also be implemented by a component (for example, a chip or a circuit) in the first apparatus, and the method and the operation implemented by the second apparatus may also be implemented by a component (for example, a chip or a circuit) in the second apparatus.

The foregoing mainly describes, from a perspective of interaction between network elements, the solutions provided in embodiments of this application. It may be understood that, to implement the foregoing functions, each network element such as a transmitter device or a receiver device includes a corresponding hardware structure and/or software module for performing each function. A person skilled in the art should be able to be aware that, in combination with units and algorithm steps of the examples described in embodiments disclosed in this specification, this application can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, a transmitter device or a receiver device may be divided into functional modules based on the foregoing method examples. For example, each functional module may be obtained through division based on each corresponding function, or two or more functions may be integrated into one processing module. The integrated module may be implemented in a form of hardware, or may be implemented in a form of a software functional module. It should be noted that, in embodiments of this application, division into the modules is an example and is merely logical function division, and may be other division in an actual implementation. Descriptions are provided below by using an example in which each functional module is obtained through division based on each corresponding function.

FIG. 13 is a block diagram of a communication apparatus according to an embodiment of this application. The communication apparatus 1300 shown in FIG. 13 includes a transceiver unit 1310 and a processing unit 1320. The transceiver unit 1310 may communicate with the outside, and the processing unit 1320 is configured to process data. The transceiver unit 1310 may also be referred to as a communication interface or a communication unit.

Optionally, the transceiver unit 1310 may include a sending unit and a receiving unit. The sending unit is configured to perform a sending operation in the foregoing method embodiments. The receiving unit is configured to perform a receiving operation in the foregoing method embodiments.

It should be noted that the communication apparatus 1300 may include the sending unit, but does not include the receiving unit. Alternatively, the communication apparatus 1300 may include the receiving unit, but does not include the sending unit. This may be determined depending on whether the foregoing solution performed by the communication apparatus 1300 includes a sending action and a receiving action.

Optionally, the communication apparatus 1300 may further include a storage unit. The storage unit may be configured to store instructions and/or data. The processing unit 1320 may read the instructions and/or the data in the storage unit.

In a design, the communication apparatus 1300 may be configured to perform an action performed by the first apparatus in the foregoing method embodiment.

Optionally, the communication apparatus 1300 may be the first apparatus. The transceiver unit 1310 is configured to perform a receiving or sending operation of the first apparatus in the foregoing method embodiment. The processing unit 1320 is configured to perform an internal processing operation of the first apparatus in the foregoing method embodiment.

Optionally, the communication apparatus 1300 may be a device including the first apparatus. Alternatively, the communication apparatus 1300 may be a component configured in the first apparatus, for example, a chip in the first apparatus. In this case, the transceiver unit 1310 may be an interface circuit, a pin, or the like. The interface circuit may include an input circuit and an output circuit, and the processing unit 1320 may include a processing circuit.

In an implementation, the transceiver unit 1310 is configured to receive K signals, where the K signals are in one-to-one correspondence with K ports; and the processing unit 1320 is configured to measure the K signals to obtain measurement results, where the measurement results are used to determine channel state information corresponding to R ports, R is greater than K, and K is greater than or equal to 1.

In an implementation, the transceiver unit 1310 is further configured to send the measurement results, where the measurement results and a correspondence between the K ports and the R ports are used to determine the channel state information.

In an implementation, the processing unit 1320 is further configured to determine, based on the measurement results and a correspondence between the K ports and the R ports, the channel state information corresponding to the R ports; and the transceiver unit 1310 is further configured to send the channel state information.

In an implementation, the K signals correspond to at least one of the following: a first antenna subarray set of a second apparatus and a second antenna subarray set of a third apparatus, where the first antenna subarray set includes at least one antenna subarray, the second antenna subarray set includes at least one antenna subarray, and the antenna subarray includes at least one antenna.

In an implementation, the transceiver unit 1310 is further configured to obtain first information, where the first information is used to determine the correspondence between the K ports and the R ports, and the first information includes at least one of the following: quantity information of the antenna subarray in the first antenna subarray set, quantity information of the antenna subarray in the second antenna subarray set, quantity information of antennas in the antenna subarray, and information about a correspondence between the antenna subarray and antennas for sending the K signals.

In an implementation, the K signals correspond to at least one of the following: a first antenna set that is determined by a second apparatus and that is used for channel measurement, and a second antenna set that is determined by a third apparatus and that is used for channel measurement.

In an implementation, the transceiver unit 1310 is further configured to obtain second information, where the second information is used to determine the correspondence between the K ports and the R ports, and the second information includes at least one of the following: information about a distance from an antenna in the first antenna set to an antenna panel center, phase information of the antenna in the first antenna set, information about a distance from an antenna in the second antenna set to an antenna panel center, and phase information of the antenna in the second antenna set.

In an implementation, the transceiver unit 1310 is further configured to obtain third information, where the third information is used to determine the correspondence between the K ports and the R ports, and the third information includes at least one of the following: row information of an antenna in the first antenna set in a horizontal direction of an antenna panel, column information of the antenna in the first antenna set in a vertical direction of the antenna panel, row information of an antenna in the second antenna set in a horizontal direction of an antenna panel, and column information of the antenna in the second antenna set in a vertical direction of the antenna panel.

In another design, the communication apparatus 1300 shown in FIG. 13 may be configured to perform an action performed by the second apparatus in the foregoing method embodiment.

Optionally, the communication apparatus 1300 may be the second apparatus. The transceiver unit 1310 is configured to perform a receiving or sending operation of the second apparatus in the foregoing method embodiment. The processing unit 1320 is configured to perform an internal processing operation of the second apparatus in the foregoing method embodiment.

Optionally, the communication apparatus 1300 may be a device including the second apparatus. Alternatively, the communication apparatus 1300 may be a component configured in the second apparatus, for example, a chip in the second apparatus. In this case, the transceiver unit 1310 may be an interface circuit, a pin, or the like. The interface circuit may include an input circuit and an output circuit, and the processing unit 1320 may include a processing circuit.

In an implementation, the transceiver unit 1310 is configured to send K signals, where the K signals are used for channel measurement, and the K signals are in one-to-one correspondence with K ports; and the transceiver unit 1310 is further configured to obtain channel state information corresponding to R ports, where the channel state information is determined based on measurement results of the K signals, R is greater than K, and K is greater than or equal to 1.

In an implementation, the transceiver unit 1310 is further configured to receive the measurement results of the K signals; and the processing unit 1320 is configured to determine the channel state information based on the measurement results and a correspondence between the K ports and the R ports.

In an implementation, the K signals correspond to at least one of the following: a first antenna subarray set of the second apparatus and a second antenna subarray set of a third apparatus, where the first antenna subarray set includes at least one antenna subarray, the second antenna subarray set includes at least one antenna subarray, and the antenna subarray includes at least one antenna.

In an implementation, the transceiver unit 1310 is further configured to send first information, where the first information is used to determine the correspondence between the K ports and the R ports, and the first information includes at least one of the following: quantity information of the antenna subarray in the first antenna subarray, quantity information of the antenna subarray in the second antenna subarray, quantity information of the antenna in the antenna subarray, and information about a correspondence between the antenna subarray and antennas for sending the K signals.

In an implementation, the K signals correspond to at least one of the following: a first antenna set that is determined by the second apparatus and that is used for channel measurement, and a second antenna set that is determined by a third apparatus and that is used for channel measurement.

In an implementation, the transceiver unit 1310 is further configured to send second information, where the second information is used to determine the correspondence between the K ports and the R ports, and the second information includes at least one of the following: information about a distance from an antenna in the first antenna set to an antenna panel center, phase information of the antenna in the first antenna set, information about a distance from an antenna in the second antenna set to an antenna panel center, and phase information of the antenna in the second antenna set.

In an implementation, the transceiver unit 1310 is further configured to send third information, where the third information is used to determine the correspondence between the K ports and the R ports, and the third information includes at least one of the following: row information of an antenna in the first antenna set in a horizontal direction of an antenna panel, column information of the antenna in the first antenna set in a vertical direction of the antenna panel, row information of an antenna in the second antenna set in a horizontal direction of an antenna panel, and column information of the antenna in the second antenna set in a vertical direction of the antenna panel.

As shown in FIG. 14, an embodiment of this application further provides a communication apparatus 1400. The communication apparatus 1400 includes a processor 1410. The processor 1410 is coupled to a memory 1420. The memory 1420 is configured to store a computer program or instructions and/or data. The processor 1410 is configured to execute the computer program or the instructions and/or the data stored in the memory 1420, to perform the method in the foregoing method embodiment.

Optionally, the communication apparatus 1400 includes one or more processors 1410.

Optionally, as shown in FIG. 14, the communication apparatus 1400 may further include the memory 1420.

Optionally, the communication apparatus 1400 may include one or more memories 1420.

Optionally, the memory 1420 and the processor 1410 may be integrated together, or separately disposed.

Optionally, as shown in FIG. 14, the communication apparatus 1400 may further include a transceiver 1430 and/or a communication interface. The transceiver 1430 and/or the communication interface are/is configured to: receive and/or send a signal. For example, the processor 1410 is configured to control the transceiver 1430 and/or the communication interface to receive and/or send a signal.

Optionally, a component that is in the transceiver 1430 and that is configured to implement a receiving function may be considered as a receiving module, and a component that is in the transceiver 1430 and that is configured to implement a sending function may be considered as a sending module. In other words, the transceiver 1430 includes a receiver and a transmitter. The transceiver may also be sometimes referred to as a transceiver machine, a transceiver module, a transceiver circuit, or the like. The receiver may also be sometimes referred to as a receiver machine, a receiving module, a receiving circuit, or the like. The transmitter may also be sometimes referred to as a transmitter machine, a transmitter, a transmitting module, a transmitting circuit, or the like.

In a solution, the communication apparatus 1400 is configured to implement an operation performed by the first apparatus in the foregoing method embodiment. For example, the processor 1410 is configured to implement operations (for example, an operation in S220 or S230′) performed inside the first apparatus in the foregoing method embodiment, and the transceiver 1430 is configured to implement a receiving or sending operation (for example, an operation in S210, S230, S221, S222, S223, or S231′) performed by the first apparatus in the foregoing method embodiment.

In a solution, the communication apparatus 1400 is configured to implement an operation performed by the second apparatus in the foregoing method embodiment. For example, the processor 1410 is configured to implement an operation (for example, an operation in S231) performed inside the second apparatus in the foregoing method embodiment, and the transceiver 1430 is configured to implement a receiving or sending operation (for example, an operation in S210, S230, S221, S222, S223, or S231′) performed by the second apparatus in the foregoing method embodiment.

An embodiment of this application further provides a communication apparatus 1500. The communication apparatus 1500 may be a terminal device or a network device, or may be a chip in the terminal device or the network device. The communication apparatus 1500 may be configured to perform an operation performed by the first apparatus or the second apparatus in the foregoing method embodiment.

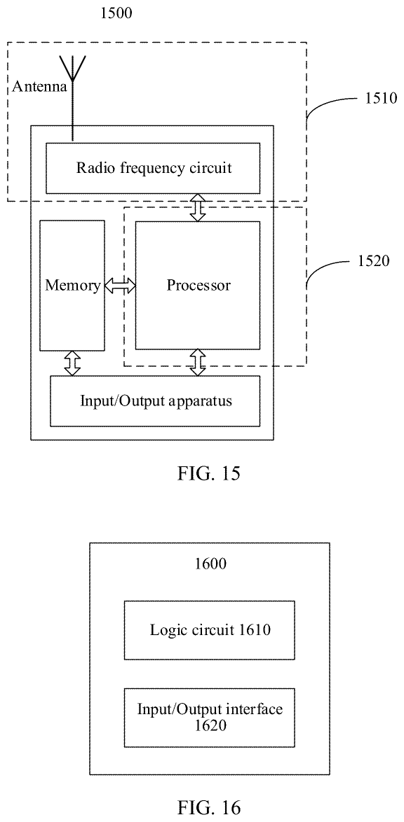

FIG. 15 is a simplified diagram of a structure of a communication apparatus. As shown in FIG. 15, the communication apparatus 1500 includes a processor, a memory, a radio frequency circuit, an antenna, and an input/output apparatus. The processor is mainly configured to: process a communication protocol and communication data, control the communication apparatus 1500, execute a software program, process data of the software program, and the like. The memory is mainly configured to store the software program and data. The radio frequency circuit is mainly configured to: perform conversion between a baseband signal and a radio frequency signal, and process the radio frequency signal. The antenna is mainly configured to: receive and send a radio frequency signal in a form of an electromagnetic wave. The input/output apparatus, for example, a touchscreen, a display, or a keyboard, is mainly configured to: receive data input by a user, and output data to the user.

When data needs to be sent, the processor performs baseband processing on the to-be-sent data, and then outputs a baseband signal to the radio frequency circuit, and the radio frequency circuit performs radio frequency processing on the baseband signal, and then sends a radio frequency signal to the outside in a form of an electromagnetic wave through the antenna. When data is sent to the communication apparatus 1500, the radio frequency circuit receives the radio frequency signal through the antenna, converts the radio frequency signal into a baseband signal, and outputs the baseband signal to the processor. The processor converts the baseband signal into data and processes the data. For ease of description, FIG. 15 shows only one memory and one processor. In an actual product, there may be one or more processors and one or more memories. The memory may also be referred to as a storage medium, a storage device, or the like. The memory may be disposed independent of the processor, or may be integrated with the processor. This is not limited in embodiments of this application.

In this embodiment of this application, the antenna and the radio frequency circuit that have a transceiver function may be considered as a transceiver unit of the communication apparatus 1500, and the processor that has a processing function may be considered as a processing unit of the communication apparatus 1500.

As shown in FIG. 15, the communication apparatus 1500 includes a transceiver unit 1510 and a processing unit 1520. The transceiver unit 1510 may also be referred to as a transceiver, a transceiver machine, a transceiver apparatus, a transceiver circuit, or the like. The processing unit 1520 may also be referred to as a processor, a processing board, a processing module, a processing apparatus, or the like.

Optionally, a component that is in the transceiver unit 1510 and that is configured to implement a receiving function may be considered as a receiving unit, and a component that is in the transceiver unit 1510 and that is configured to implement a sending function may be considered as a sending unit. That is, the transceiver unit 1510 includes the receiving unit and the sending unit. The receiving unit may also be referred to as a receiver machine, a receiver, a receiving apparatus, a receiving circuit, or the like. The sending unit may also be referred to as a transmitter machine, a transmitter, a transmitting apparatus, a transmitting circuit, or the like.

In an implementation, the processing unit 1520 and the transceiver unit 1510 are configured to perform an operation on the first apparatus side.

For example, the processing unit 1520 is configured to perform an operation in S220 or S230′. The transceiver unit 1510 is configured to perform receiving and sending operations in S210, S230, S221, S222, S223, or S231′.

In another implementation, the processing unit 1520 and the transceiver unit 1510 are configured to perform an operation on the second apparatus side.

For example, the processing unit 1520 is configured to perform an operation in S231. The transceiver unit 1510 is configured to perform receiving and sending operations in S210, S230, S221, S222, S223, or S231′.

It should be understood that FIG. 15 is merely an example rather than a limitation. The communication apparatus 1500 including the transceiver unit and the processing unit may not depend on the structure shown in FIG. 15.

When the communication apparatus 1500 is a chip, the chip includes a transceiver unit and a processing unit. The transceiver unit may be an input/output circuit or a communication interface. The processing unit may be a processor, a microprocessor, or an integrated circuit integrated on the chip.

As shown in FIG. 16, an embodiment of this application further provides a communication apparatus 1600. The communication apparatus 1600 includes a logic circuit 1610 and an input/output interface (input/output interface) 1620.

The logic circuit 1610 may be a processing circuit in the communication apparatus 1600. The logic circuit 1610 may be connected to a storage unit through coupling, and invoke instructions in the storage unit, so that the communication apparatus 1600 can implement the methods and functions in embodiments of this application. The input/output interface 1620 may be an input/output circuit in the communication apparatus 1600, and outputs information processed by the communication apparatus 1600, or inputs to-be-processed data or signaling information to the communication apparatus 1600 for processing.

In a solution, the communication apparatus 1600 is configured to implement an operation performed by the first apparatus in the foregoing method embodiments.

For example, the logic circuit 1610 is configured to implement a processing-related operation performed by the first apparatus in the foregoing method embodiment, for example, configured to implement a processing operation in S220 or S230′. The input/output interface 1620 is configured to implement a sending and/or receiving-related operation performed by the first apparatus in the foregoing method embodiment, for example, receiving and sending operations of the first apparatus in S210, S230, S221, S222, S223, or S231′. For an operation performed by the logic circuit 1610, refer to the foregoing description of the processing unit 1320. For an operation performed by the input/output interface 1620, refer to the foregoing description of the transceiver unit 1310. Details are not described herein again.

In another solution, the communication apparatus 1600 is configured to implement an operation performed by the second apparatus in the foregoing method embodiments.

For example, the logic circuit 1610 is configured to implement a processing-related operation performed by the second apparatus in the foregoing method embodiment, for example, configured to implement a processing operation of the second apparatus in S231. The input/output interface 1620 is configured to implement a sending and/or receiving-related operation performed by the second apparatus in the foregoing method embodiment, for example, receiving and sending operations of the second apparatus in S210, S230, S221, S222, S223, or S231′. For an operation performed by the logic circuit 1610, refer to the foregoing description of the processing unit 1320. For an operation performed by the input/output interface 1620, refer to the foregoing description of the transceiver unit 1310. Details are not described herein again.

It should be understood that, the communication apparatus may be one or more chips. For example, the communication apparatus may be a field programmable gate array (FPGA), an application-specific integrated chip (ASIC), a system on chip (SoC), a central processing unit (CPU), a network processor (NP), a digital signal processor (DSP), a micro controller unit (MCU), a programmable logic device (PLD), or another integrated chip.

In an implementation process, steps in the foregoing methods can be implemented by using a hardware integrated logical circuit in the processor, or by using instructions in a form of software. The steps of the methods disclosed with reference to embodiments of this application may be directly performed and implemented by a hardware processor, or may be performed and implemented by using a combination of hardware in the processor and a software module. The software module may be located in a mature storage medium in the art such as a random access memory, a flash memory, a read-only memory, a programmable read-only memory, an electrically erasable programmable memory, or a register. The storage medium is located in the memory, and the processor reads information in the memory and completes the steps in the foregoing methods in combination with hardware of the processor. To avoid repetition, details are not described herein again.

It should be noted that, the processor in embodiments of this application may be an integrated circuit chip, and has a signal processing capability. In an implementation process, steps in the foregoing method embodiments can be implemented by using a hardware integrated logical circuit in the processor, or by using instructions in a form of software. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or perform the methods, steps, and logical block diagrams that are disclosed in embodiments of this application. The general-purpose processor may be a microprocessor, or the processor may be any conventional processor or the like. The steps in the methods disclosed with reference to embodiments of this application may be directly performed and completed by a hardware decoding processor, or may be performed and completed by using a combination of hardware in the decoding processor and a software module. The software module may be located in a mature storage medium in the art such as a random access memory, a flash memory, a read-only memory, a programmable read-only memory, an electrically erasable programmable memory, or a register. The storage medium is located in the memory, and the processor reads information in the memory and completes the steps in the foregoing methods in combination with hardware of the processor.

It may be understood that the memory in this embodiment of this application may be a volatile memory or a nonvolatile memory, or may include a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example, and not limitation, RAMs in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). It should be noted that the memory in the system and methods described in this specification includes but is not limited to these and any memory of another proper type.

According to the method provided in embodiments of this application, this application further provides a computer-readable medium. The computer-readable medium stores program code. When the program code is run on a computer, the computer is enabled to perform the method shown in the method embodiments. For example, when a computer program is executed by a computer, the computer is enabled to implement the method performed by the first apparatus or the method performed by the second apparatus in the foregoing method embodiment.

An embodiment of this application further provides a computer program product including instructions. When the instructions are executed by a computer, the computer i s enabled to implement the method performed by the first apparatus or the method performed by the second apparatus in the foregoing method embodiment.

For explanations and beneficial effects of related content in any communication apparatus provided above, refer to the corresponding method embodiment provided above. Details are not described herein again.

All or some of the foregoing embodiments may be implemented by using software, hardware, firmware, or any combination thereof. When software is used to implement the embodiments, all or some of embodiments may be implemented in a form of a computer program product. The computer program product includes one or more computer instructions. When the computer instructions are loaded and executed on the computer, the procedure or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, a solid-state drive (SSD)), or the like.

The first apparatus and the second apparatus in the foregoing apparatus embodiments correspond to the first apparatus and the second apparatus in the method embodiments, and corresponding modules or units perform corresponding steps. For example, a communication unit (transceiver) performs a receiving or sending step in the method embodiments, and a processing unit (processor) may perform a step other than the sending and receiving steps. For a function of a specific unit, refer to a corresponding method embodiment. There may be one or more processors.

Terms such as “component”, “module”, and “system” used in this specification indicate computer-related entities, hardware, firmware, combinations of hardware and software, software, or software being executed. For example, the component may be but is not limited to a process that runs on a processor, the processor, an object, an executable file, an execution thread, a program, and/or a computer. As illustrated by using figures, both a computing device and an application that runs on the computing device may be components. One or more components may reside within a process and/or a thread of execution, and a component may be located on one computer and/or distributed between two or more computers. In addition, these components may be executed from various computer-readable media that store various data structures. For example, the components may communicate by using a local and/or remote process and based on a signal having one or more data packets (for example, data from two components interacting with another component in a local system, a distributed system, and/or across a network such as the internet interacting with another system by using the signal).

A person of ordinary skill in the art may be aware that, in combination with units and algorithm steps of the examples described in embodiments disclosed in this specification, this application can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, and may be located in one position, or may be distributed on a plurality of network units. Some or a part of the units may be selected based on actual requirements to achieve the objectives of the solutions of embodiments.

In addition, functional units in embodiments of this application may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A channel measurement method, comprising:
receiving, by a first apparatus, K signals, the K signals being in one-to-one correspondence with K ports; and
measuring, by the first apparatus, the K signals to obtain measurement results, the measurement results being used to determine channel state information corresponding to R ports, R is greater than K, and K is greater than or equal to 1.

2. The method according to claim 1, the method further comprising:
determining, by the first apparatus based on the measurement results and a correspondence between the K ports and the R ports, the channel state information corresponding to the R ports; and
sending, by the first apparatus, the channel state information.

3. The method according to claim 1, the method further comprising:
sending, by the first apparatus, the measurement results, wherein the measurement results and a correspondence between the K ports and the R ports are used to determine the channel state information.

4. The method according to claim 1, wherein the K signals correspond to at least one of:
a first antenna subarray set of a second apparatus or a second antenna subarray set of a third apparatus, wherein the first antenna subarray set comprises at least one antenna subarray, the second antenna subarray set comprises at least one antenna subarray, and the antenna subarray comprises at least one antenna.

5. The method according to claim 4, the method further comprising:
obtaining, by the first apparatus, first information, wherein the first information is used to determine the correspondence between the K ports and the R ports, and the first information comprises at least one of: quantity information of the antenna subarray in the first antenna subarray set, quantity information of the antenna subarray in the second antenna subarray set, quantity information of antennas in the antenna subarray, or information about a correspondence between the antenna subarray and antennas for sending the K signals.

6. The method according to claim 1, wherein the K signals correspond to at least one of a first antenna set that is determined by a second apparatus and that is used for channel measurement, or a second antenna set that is determined by a third apparatus and that is used for channel measurement.

7. The method according to claim 6, the method further comprising:
obtaining, by the first apparatus, second information, wherein the second information is used to determine a correspondence between the K ports and the R ports, and the second information comprises at least one of information about a distance from an antenna in the first antenna set to an antenna panel center, phase information of the antenna in the first antenna set, information about a distance from an antenna in the second antenna set to an antenna panel center, or phase information of the antenna in the second antenna set.

8. The method according to claim 6, the method further comprising:
obtaining, by the first apparatus, third information, wherein the third information is used to determine a correspondence between the K ports and the R ports, and the third information comprises at least one of: row information of an antenna in the first antenna set in a horizontal direction of an antenna panel, column information of the antenna in the first antenna set in a vertical direction of the antenna panel, row information of an antenna in the second antenna set in a horizontal direction of an antenna panel, or column information of the antenna in the second antenna set in a vertical direction of the antenna panel.

9. A channel measurement method, comprising:
sending, by a second apparatus, K signals, the K signals being used for channel measurement, and the K signals are in one-to-one correspondence with K ports; and
obtaining, by the second apparatus, channel state information corresponding to R ports, the channel state information being determined based on measurement results of the K signals, R is greater than K, and K is greater than or equal to 1.

10. The method according to claim 9, wherein the obtaining, by the second apparatus, the channel state information corresponding to the R ports comprises:
receiving, by the second apparatus, the measurement results of the K signals; and
determining, by the second apparatus, the channel state information based on the measurement results and a correspondence between the K ports and the R ports.

11. The method according to claim 9, wherein the K signals correspond to at least one of:
a first antenna subarray set of the second apparatus or a second antenna subarray set of a third apparatus, wherein the first antenna subarray set comprises at least one antenna subarray, the second antenna subarray set comprises at least one antenna subarray, and the antenna subarray comprises at least one antenna.

12. The method according to claim 11, the method further comprising:
sending, by the second apparatus, first information, wherein the first information is used to determine a correspondence between the K ports and the R ports, and the first information comprises at least one of: quantity information of the antenna subarray in the first antenna subarray set, quantity information of the antenna subarray in the second antenna subarray set, quantity information of the antenna in the antenna subarray, or information about a correspondence between the antenna subarray and antennas for sending the K signals.

13. The method according to claim 9, wherein the K signals correspond to at least one of:
a first antenna set that is determined by the second apparatus and that is used for channel measurement, or a second antenna set that is determined by a third apparatus and that is used for channel measurement.

14. The method according to claim 13, the method further comprising:
sending, by the second apparatus, second information, wherein the second information is used to determine a correspondence between the K ports and the R ports, and the second information comprises at least one of information about a distance from an antenna in the first antenna set to an antenna panel center, phase information of the antenna in the first antenna set, information about a distance from an antenna in the second antenna set to an antenna panel center, or phase information of the antenna in the second antenna set.

15. The method according to claim 13, the method further comprising:
sending, by the second apparatus, third information, wherein the third information is used to determine a correspondence between the K ports and the R ports, and the third information comprises at least one of: row information of an antenna in the first antenna set in a horizontal direction of an antenna panel, column information of the antenna in the first antenna set in a vertical direction of the antenna panel, row information of an antenna in the second antenna set in a horizontal direction of an antenna panel, or column information of the antenna in the second antenna set in a vertical direction of the antenna panel.

16. A communication apparatus, comprising:
a transceiver configured to receive K signals, the K signals being in one-to-one correspondence with K ports; and
a processor coupled to the transceiver, the processor being configured to measure the K signals to obtain measurement results, the measurement results being used to determine channel state information corresponding to R ports, R is greater than K, and K is greater than or equal to 1.

17. The apparatus according to claim 16, wherein the processing unit is further configured to determine, based on the measurement results and a correspondence between the K ports and the R ports, channel state information corresponding to the R ports; and
the transceiver unit is further configured to send the channel state information.

18. The apparatus according to claim 16, wherein the transceiver unit is further configured to send the measurement results, wherein the measurement results and a correspondence between the K ports and the R ports are used to determine the channel state information.

19. The apparatus according to claim 16, wherein the K signals correspond to at least one of a first antenna subarray set of a second apparatus or a second antenna subarray set of a third apparatus, wherein the first antenna subarray set comprises at least one antenna subarray, the second antenna subarray set comprises at least one antenna subarray, and the antenna subarray comprises at least one antenna.

20. The apparatus according to claim 19, wherein the transceiver unit is further configured to obtain first information, wherein the first information is used to determine a correspondence between the K ports and the R ports, and the first information comprises at least one of: quantity information of the antenna subarray in the first antenna subarray set, quantity information of the antenna subarray in the second antenna subarray set, quantity information of antennas in the antenna subarray, or information about a correspondence between the antenna subarray and antennas for sending the K signals.
